(19) United States
(12) Patent Application Publication
(10) Pub. No.: US 2026/0205147 A1
(43) Pub. Date: Jul. 16, 2026

(54) ANTENNA MODULE AND ELECTRONIC DEVICE INCLUDING SAME

(71) Applicant: Samsung Electronics Co., Ltd., Suwon-si (KR)

(72) Inventor: Hyosung LEE, Suwon-si (KR)

(21) Appl. No.: 19/560,911

(22) Filed: Mar. 9, 2026

Related U.S. Application Data
(63) Continuation of application No. PCT/KR2025/022023, filed on Dec. 17, 2025.

(30) Foreign Application Priority Data
Dec. 24, 2024 (KR) 10-2024-0196312
Feb. 17, 2025 (KR) 10-2025-0020455

(51) Int. Cl. H04B 1/00; H04B 1/44

(52) U.S. Cl. CPC H04B 1/0096; H04B 1/0007; H04B 1/44

(57) ABSTRACT

An electronic device includes a processor, intermediate frequency processing circuitry, radio frequency processing circuitry, and antennas. The radio frequency processing circuitry includes first transmission circuitry including first transmission processing circuitry for a first frequency band and second transmission processing circuitry for a second frequency band, second transmission circuitry including third transmission processing circuitry for the first frequency band and fourth transmission processing circuitry for the second frequency band, first reception circuitry including first reception processing circuitry for the first frequency band and second reception processing circuitry for the second frequency band, second reception circuitry including third reception processing circuitry for the first frequency band and fourth reception processing circuitry for the second frequency band, a first transmit-receive switching circuit configured to connect a first port connected to the intermediate frequency processing circuitry to one of the first transmission circuitry and the first reception circuitry, a second transmit-receive switching circuit connecting a second port to one of the second transmission circuitry and the second reception circuitry, a first control switching circuit configured to connect the first port connected to the intermediate frequency processing circuitry to the second transmission circuitry, and a second control switching circuit configured to connect the second port connected to the intermediate frequency processing circuitry to the first reception circuitry.

### CROSS-REFERENCE TO RELATED APPLICATIONS

This application is a continuation application, claiming priority under 35 U.S.C. §365(c), of an International application No. PCT/KR2025/022023, filed on Dec. 17, 2025, which is based on and claims the benefit of a Korean patent application number 10-2024-0196312, filed on Dec. 24, 2024, in the Ministry of Intellectual Property, and of a Korean patent application number 10-2025-0020455, filed on Feb. 17, 2025, in the Ministry of Intellectual Property, the disclosures of each of which are incorporated by reference herein in their entireties.

### BACKGROUND

### Field

The disclosure relates to an antenna module and an electronic device including the same.

### Description of Related Art

An electronic device may include an antenna module for wireless communication with an external device. The antenna module may include a plurality of antennas and radio frequency processing circuitry. The antenna module may include the plurality of antennas as an array antenna for beamforming.

The above-described information may be provided as a related art for the purpose of helping understanding of the present disclosure. No assertion or determination is made as to whether any of the above description may be applied as a prior art related to the present disclosure.

### SUMMARY

According to various example embodiments of the disclosure, an electronic device is provided. The electronic device may comprise: at least one processor, comprising processing circuitry, intermediate frequency processing circuitry connected to the at least one processor, radio frequency processing circuitry connected to the intermediate frequency processing circuitry, and antennas connected to the radio frequency processing circuitry. The radio frequency processing circuitry may include first transmission circuitry including first transmission processing circuitry for a first frequency band and second transmission processing circuitry for a second frequency band, second transmission circuitry including third transmission processing circuitry for the first frequency band and fourth transmission processing circuitry for the second frequency band, first reception circuitry including first reception processing circuitry for the first frequency band and second reception processing circuitry for the second frequency band, second reception circuitry including third reception processing circuitry for the first frequency band and fourth reception processing circuitry for the second frequency band, a first transmit-receive switching circuit configured to connect a first port connected to the intermediate frequency processing circuitry to one of the first transmission circuitry and the first reception circuitry selectively, a second transmit-receive switching circuit configured to selectively connect a second port configured to be connected to the intermediate frequency processing circuitry to one of the second transmission circuitry and the second reception circuitry, a first control switching circuit configured to selectively connect the first port connected to the intermediate frequency processing circuitry to the second transmission circuitry, and a second control switching circuit configured to selectively connect the second port connected to the intermediate frequency processing circuitry to the first reception circuitry.

According to various example embodiments of the disclosure, an antenna module is provided. The antenna module may comprise: a first port, a second port, radio frequency processing circuitry connected to the first port and the second port, and antennas connected to the radio frequency processing circuitry. The radio frequency processing circuitry may include first transmission circuitry including first transmission processing circuitry for a first frequency band and second transmission processing circuitry for a second frequency band, second transmission circuitry including third transmission processing circuitry for the first frequency band and fourth transmission processing circuitry for the second frequency band, first reception circuitry including first reception processing circuitry for the first frequency band and second reception processing circuitry for the second frequency band, second reception circuitry including third reception processing circuitry for the first frequency band and fourth reception processing circuitry for the second frequency band, a first transmit-receive switching circuit configured to selectively connect the first port to one of the first transmission circuitry and the first reception circuitry, a second transmit-receive switching circuit configured to selectively connect the second port to one of the second transmission circuitry and the second reception circuitry selectively, a first control switching circuit configured to selectively connect the first port to the second transmission circuitry, and a second control switching circuit configured to selectively connect the second port to the first reception circuitry.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a diagram illustrating an example of an electronic device including an antenna module according to various embodiments;

FIGS. 3A and 3B is a diagram illustrating an example of an antenna module according to various embodiments;

FIGS. 4A, 4B, and 4C are graphs illustrating an example of communication in a first frequency band and communication in a second frequency band according to a frequency division duplex (FDD) method according to various embodiments;

FIG. 5 is a diagram illustrating an example configuration of radio frequency processing circuitry according to various embodiments;

FIGS. 6A, 6B, and 6C are diagrams illustrating example operation of components of radio frequency processing circuitry for each mode according to various embodiments;

FIG. 7 is a diagram illustrating an example configuration of radio frequency processing circuitry in a first communication type according to various embodiments;

FIG. 8A is a diagram illustrating an example configuration of radio frequency processing circuitry in a second communication type according to various embodiments;

FIG. 8B is a diagram illustrating an example configuration of radio frequency processing circuitry in a third communication type according to various embodiments;

FIG. 9 is a diagram illustrating an example configuration of radio frequency processing circuitry in a fourth communication type according to various embodiments;

FIG. 10 is a diagram illustrating an example configuration of intermediate frequency processing circuitry according to various embodiments; and

FIG. 11 is a diagram illustrating an example configuration of radio frequency processing circuitry for transmit-receive switching between ports according to various embodiments.

### DETAILED DESCRIPTION

Terms used in the present disclosure are used to describe various example embodiments, and are not intended to limit a scope of the disclosure. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term referring to a part of an electronic device (e.g., a substrate, a printed circuit board (PCB), a flexible PCB (FPCB), a printed board assembly (PBA), a module, an antenna element, circuitry, a processor, a chip, a component, or a device), a term referring to components of an antenna (e.g., an antenna element, an antenna radiator, a radiator, a patch radiator, a conductive portion, a conductive pattern, a coil, a conductive member, a radiating member, a radiating material, a radiating part, an antenna structure, an antenna construction, a feeding portion, a feeding member, a radio frequency (RF) line, an RF line construction, a connection member, a connection portion, or a contact member), a term referring to a position of a component (e.g., a portion, a position, an area, or a point), a term referring to a space physically spaced apart between a portion and another portion (e.g., a gap, a slot, a crack, an opening, and a hole), a term referring to a shape of a part (e.g., a structure, a construction, a support unit, a contact unit, a flange, or a protrusion) a term for a connection unit between structures (e.g., a connection unit, a connection portion, a contact unit, a contact portion, a support unit, a support portion, a connection structure, a support structure, a contact structure, contact structure, contact structure, contact structure, contact structure, contact structure, a conductive member, a conductive pad, a conductive pattern, or an assembly), a term referring to an open structure (e.g., a slot, a slit, or an opening), a term referring to circuitry (e.g., a PCB, a FPCB, a signal line, a ground line, a feeding line, a data line, an RF signal line, an antenna line, an RF path, an RF module, RF circuitry, distribution circuitry, a splitter, a divider, a coupler, or a combiner) used in the following description are illustrated for convenience of description. Therefore, the present disclosure is not limited to terms to be described below, and another term having an equivalent technical meaning may be used. In addition, a term such as ‘. . . unit’, ‘. . . device’, ‘. . . object’, and ‘. . . structure’, and the like used below may refer, for example, to at least one shape structure or may refer, for example, to a unit processing a function.

In the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ may refer to including at least one of ‘C’ or ‘D’, that is, {‘C’, ‘D’, and ‘C’and ‘D’}.

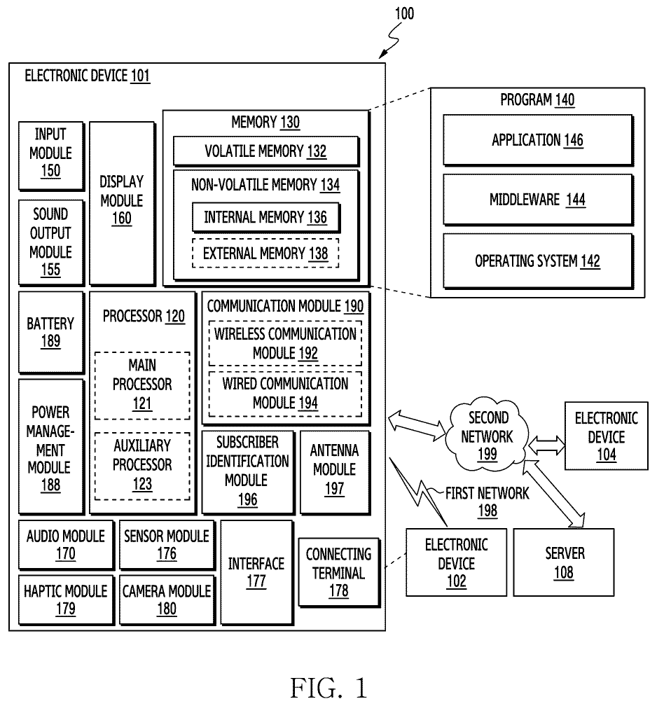

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

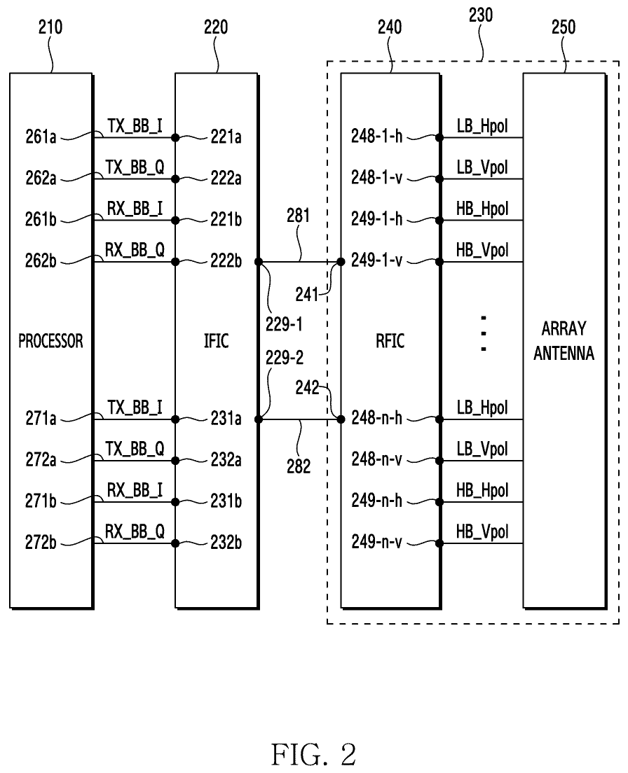

FIG. 2 is a diagram illustrating an example of an electronic device (e.g., the electronic device 101) including an antenna module according to various embodiments.

Referring to FIG. 2, the electronic device 101 may include a processor (e.g., including processing circuitry, see, e.g., description of processor 120 above) 210, an intermediate frequency processing circuitry 220, and an antenna module (e.g., including at least one antenna) 230.

The electronic device 101 may include the processor 210 including various processing circuitry. For example, the processor 210 may include at least one of an application processor (AP) (e.g., the main processor 121 of FIG. 1) or a communication processor (CP) (e.g., the auxiliary processor 123 of FIG. 1). For example, the processor 210 may include the AP and the CP. For example, the processor may include the AP. For example, the processor 210 may include the CP. The processor 210 may control the intermediate frequency processing circuitry 220 and the antenna module 230. For example, the processor 210 may generate a baseband signal. The processor 210 may control the intermediate frequency processing circuitry 220 to process the generated baseband signal. The processor 210 may convert the baseband signal into a signal of an intermediate frequency band through the intermediate frequency processing circuitry 220. The processor 210 may transmit the converted signal to the antenna module 230. The processor 210 may control the antenna module 230 to process the converted signal. The processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The electronic device 101 may include the intermediate frequency processing circuitry 220. The intermediate frequency processing circuitry 220 may be implemented as a single chip (e.g., an intermediate frequency integrated circuit (IFIC) chip) or a portion of a single package. The intermediate frequency processing circuitry 220 may be configured to process the baseband signal as the signal (hereinafter, an IF signal) of the intermediate frequency band. The intermediate frequency processing circuitry 220 may include a digital to analog converter (DAC) for converting a digital signal into an analog signal. The intermediate frequency processing circuitry 220 may include a mixer and an oscillator (e.g., a local oscillator (LO)) for up-conversion. The intermediate frequency processing circuitry 220 may convert the baseband signal generated by the processor 210 into an IF signal. The intermediate frequency processing circuitry 220 may include an analog to digital converter (ADC) for converting an analog signal into a digital signal. The intermediate frequency processing circuitry 220 may include a mixer and an oscillator for down-conversion. The intermediate frequency processing circuitry 220 may convert an IF signal received from the antenna module 230 into a baseband signal so that it may be processed by the processor 210.

The intermediate frequency processing circuitry 220 may be connected to the processor 210. According to an embodiment, the intermediate frequency processing circuitry 220, which includes the IFIC, may include a plurality of ports connected to the processor 210. A 1-1 transmission port 221a of the intermediate frequency processing circuitry 220 may be connected to a 1-1 baseband transmission path 261a (TX_BB_I). A 1-2 transmission port 222a of the intermediate frequency processing circuitry 220 may be connected to a 1-2 baseband transmission path 262a (TX_BB_Q). A 1-1 reception port 221b of the intermediate frequency processing circuitry 220 may be connected to a 1-1 baseband reception path 261b (RX_BB_I). A 1-2 reception port 222b of the intermediate frequency processing circuitry 220 may be connected to a 1-2 baseband reception path 262b (RX_BB_Q). The intermediate frequency processing circuitry 220 may be connected to the processor 210. According to an embodiment, the intermediate frequency processing circuitry 220, which is the IFIC, may include the plurality of ports connected to the processor 210. A 2-1 transmission port 231a of the intermediate frequency processing circuitry 220 may be connected to a 2-1 baseband transmission path 271a (TX_BB_I). A 2-2 transmission port 232a of the intermediate frequency processing circuitry 220 may be connected to a 2-2 baseband transmission path 272a (TX_BB_Q). A 2-1 reception port 231b of the intermediate frequency processing circuitry 220 may be connected to a 2-1 baseband reception path 271b (RX_BB_I). A 2-2 reception port 232b of the intermediate frequency processing circuitry 220 may be connected to a 2-2 baseband reception path 272b (RX_BB_Q).

According to an embodiment, the intermediate frequency processing circuitry 220 may include a plurality of ports connected to the antenna module 230. For example, the intermediate frequency processing circuitry 220 may be connected to radio frequency processing circuitry 240 through a first path 281 and a second path 282. The first path 281 may be connected to a first IF port 229-1 of the intermediate frequency processing circuitry 220. The second path 282 may be connected to a second IF port 229-2 of the intermediate frequency processing circuitry 220.

The electronic device 101 may include the antenna module 230 including at least one antenna. The antenna module 230 may include a plurality of components for RF signal processing. According to an embodiment, the antenna module 230 may include the radio frequency processing circuitry 240. The radio frequency processing circuitry 240 may be implemented as a single chip (e.g., an RFIC chip) or a portion of a single package. The radio frequency processing circuitry 240 may convert a signal of an IF frequency into a signal of an RF frequency, or may convert the signal of the RF frequency into the signal of the IF frequency. The radio frequency processing circuitry 240 may include a mixer and an oscillator (e.g., LO) for up-conversion. The radio frequency processing circuitry 240 may include a mixer and an oscillator for down-conversion. According to an embodiment, the radio frequency processing circuitry 240 may be used to process signals of a first frequency band (e.g., a frequency range (FR) 2 frequency band greater than or equal to approximately 24.25 gigahertz (GHz), n257 (greater than or equal to 26.5 GHz and less than 29.5 GHz, TDD), n258 (greater than or equal to 26.5 GHz and less than 29.5 GHz, TDD), or n261(greater than or equal to 26.5 GHz, less than 29.5 GHz, TDD)). According to an embodiment, the radio frequency processing circuitry 240 may be used to process signals of a second frequency band (e.g., the FR2 frequency band, n260 (greater than or equal to 37.0 GHz and less than 40.0 GHz, TDD), or n259 (greater than or equal to 39.5 GHz and less than 43.5 GHz, TDD)). As an example without limitation, the first frequency band may be referred to as a low-band (LB) in terms of providing a lower frequency range than the second frequency band in the FR2. The second frequency band may be referred to as a high-band (HB) in terms of providing a higher frequency range than the first frequency band in FR2.

According to an embodiment, the antenna module 230 may include an array antenna 250. A beamforming technology may be used to overcome high path loss and provide a wider signal reach area than millimeter waves. The array antenna 250 having a plurality of antenna elements may be used for the beamforming technology. The array antenna 250 may include the plurality of antenna elements. The antenna module 230 may obtain a beamforming gain, using the plurality of antenna elements. For example, the antenna module 230 may increase the beamforming gain and improve coverage by adjusting a difference between phases of RF signals applied to the plurality of antenna elements. According to an embodiment, the array antenna 250 may include a set of antenna elements for each frequency band (e.g., the first frequency band or the second frequency band).

The radio frequency processing circuitry 240, which includes an RFIC, may include a plurality of ports connected to the intermediate frequency processing circuitry 220. For example, the radio frequency processing circuitry 240 may include a first port 241 connected to the intermediate frequency processing circuitry 220 through the first path 281 and a second port 242 connected to the intermediate frequency processing circuitry 220 through the second path 282. The radio frequency processing circuitry 240, which is the RFIC, may include a plurality of RF ports connected to the array antenna 250. For example, the array antenna 250 may include a first set of antenna elements (e.g., n antenna elements) for the first frequency band and a second set of antenna elements (e.g., n antenna elements) for the second frequency band. The radio frequency processing circuitry 240 may be connected to a 1-1 antenna element among the first set of the antenna elements through a 1-1 RF port 248-1-h and a 2-1 RF port 248-1-v. The radio frequency processing circuitry 240 may be connected to a 2-1 antenna element among the second set of the antenna elements through a 3-1 RF port 249-1-h and a 4-1 RF port 249-1-v. As an example without limitation, according to a position of feeding to the 1-1 antenna element, the 1-1 RF port 248-1-h may be used to transmit or receive signals having a first polarization (e.g., a horizontal polarization) of the first frequency band (e.g., the LB). As an example without limitation, according to the position of the feeding to the 1-1 antenna element, the 2-1 RF port 248-1-v may be used to transmit or receive signals having a second polarization (e.g., a vertical polarization) of the first frequency band (e.g., the LB). As an example without limitation, according to a position of feeding to the 2-1 antenna element, the 3-1 RF port 249-1-h may be used to transmit or receive signals having a first polarization (e.g., a horizontal polarization) of the second frequency band (e.g., the HB). As an example without limitation, according to the position of the feeding to the 2-1 antenna element, the 4-1 RF port 249-1-v may be used to transmit or receive signals having a second polarization (e.g., a vertical polarization) of the second frequency band (e.g., the HB). In this way, a 1-n antenna element of the first set may be connected to the radio frequency processing circuitry 240 through a 1-nRF port 248-n-h and a 2-n RF port 248-n-v. A 2-n antenna element of the second set may be connected to the radio frequency processing circuitry 240 through a 3-n RF port 249-n-h and a 4-n RF port 249-n-v.

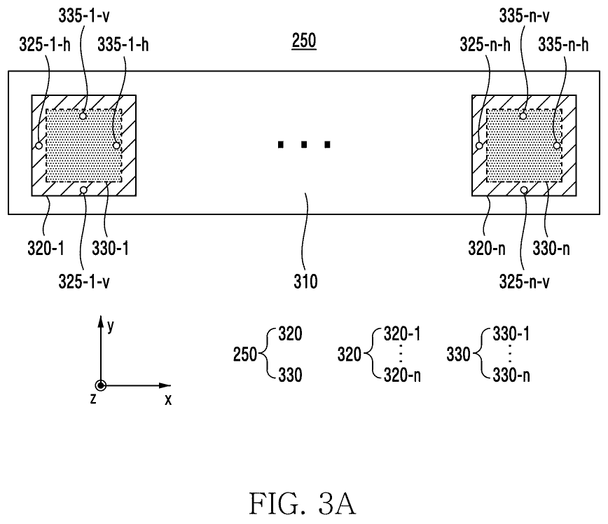

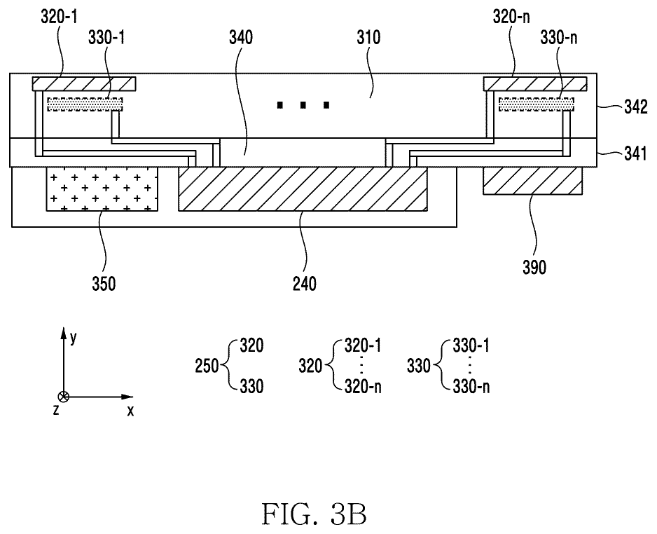

FIGS. 3A and 3B are diagrams illustrating examples of an antenna module (e.g., an antenna module 230) according to various embodiments.

Referring to FIG. 3A, an electronic device 101 may include the antenna module 230. The antenna module 230 may include a first set of antenna elements 320 (e.g., a 1-1 antenna element 320-1, . . . , and a 1-n antenna element 320-n) and a second set of antenna elements 330 (e.g., a 2-1 antenna element 330-1, . . . , and a 2-n antenna element 330-n) as the array antenna 250. The antenna module 230 may include a circuit board 310. The first set of the antenna elements 320 may be used for a first frequency band (e.g., a LB of FR2, an n257 band, an n258 band, or an n261 band). The second set of the antenna elements 330 may be used for a second frequency band (e.g., an HB of FR2, an n259 band, or an n260 band). The first set of the antenna elements 320 and the second set of the antenna elements 330 may be disposed on the circuit board 310. Each antenna element may be connected to a first feeding portion for a first polarization (e.g., a horizontal polarization) and a second feeding portion for a second polarization (e.g., a vertical polarization). For example, the 1-1 antenna element 320-1 may be connected to a 1-1-1 feeding portion 325-1-h and a 1-1-2 feeding portion 325-1-v. For example, the 2-1 antenna element 330-1 may be connected to a 2-1-1 feeding portion 335-1-h and a 2-1-2 feeding portion 335-1-v. For example, the 1-n antenna element 320-n may be connected to a 1-n-1 feeding portion 325-n-h and a 1-n-2 power supply portion 325-n-v. For example, the 2-n antenna element 330-n may be connected to a 2-n-1 feeding portion 335-n-h and a 2-n-2 feeding portion 335-n-v.

Referring to FIG. 3B, including cross-sectional view of the antenna module of FIG. 3A, the antenna module 230 may include the circuit board 310. The circuit board 310 may include a plurality of layers. The plurality of layers may include a first set of layers 341 in which feeding lines connected to radio frequency processing circuitry 240 are disposed and a second set of layers 342 in which the antenna elements are disposed. For example, the antenna elements may include the first set of the antenna elements 320 and the second set of the antenna elements 330.

The circuit board 310 may be coupled to various components. According to an embodiment, the radio frequency processing circuitry 240 may be disposed on a surface (e.g., a surface facing a (−)z axis) of the circuit board 310. According to an embodiment, power management circuitry 350 (e.g., the power management module 188 of FIG. 1 or a PMIC) may be disposed on the surface of the circuit board 310. The power management circuitry 350 may be configured to receive power from a battery (e.g., the battery 189 of FIG. 1) of the electronic device 101 and supply the radios frequency processing circuitry 240 with a stable voltage based on the power. A connector 390 may be disposed on the surface of the circuit board 310. The connector 390 may be electrically connected to a printed circuit board of the electronic device 101 through a flexible printed circuit board (FPCB). The antenna module 230 may be electrically connected to at least one component (e.g., a processor 210 or intermediate frequency processing circuitry 220) of the printed circuit board through the connector 390.

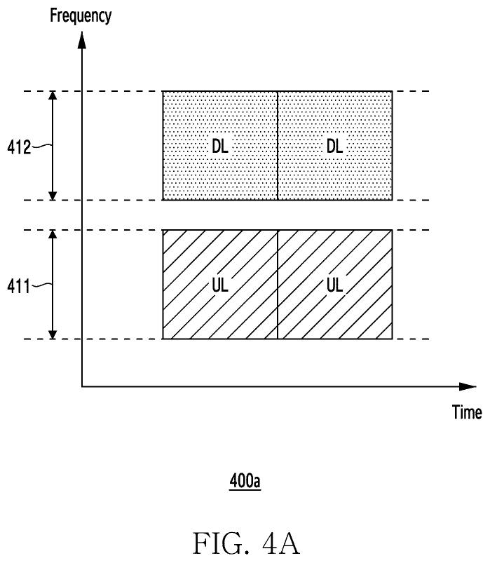

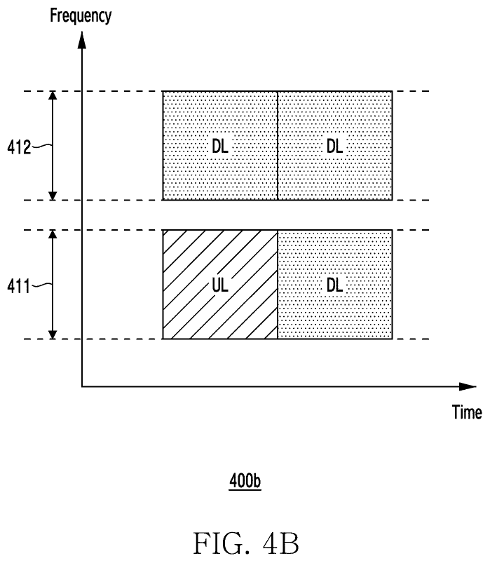

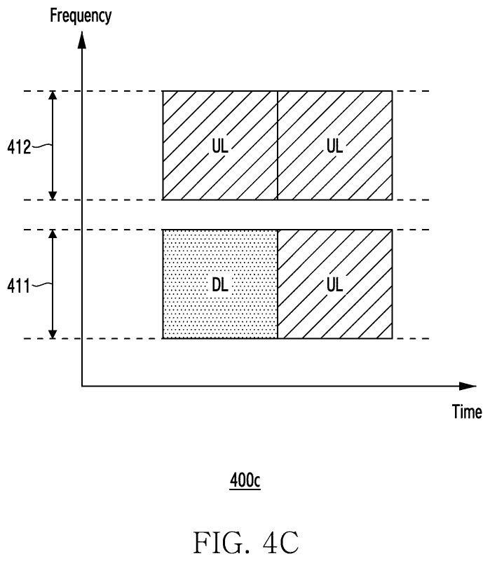

FIGS. 4A, 4B, and 4C include graphs illustrating examples of communication in a first frequency band (e.g., a LB of FR2, an n257 band, an n258 band, or an n261 band) and communication in a second frequency band (e.g., an HB of FR2, an n259 band, or an n260 band) according to frequency division duplex (FDD) method according to various embodiments. The FDD method represents a technique for segmenting transmission and reception in a frequency domain. A time division duplex (TDD) method represents a technique for segmenting transmission and reception in a time domain. A beamforming technology may be used to overcome high path loss and provide a wider signal reach area than millimeter waves. For example, an electronic device 101 may use an antenna module 230 for beamforming. Radio frequency processing circuitry 240 of the antenna module 230 may include a phase array system. For example, a signal path of the radio frequency processing circuitry 240 connected to each antenna element may include a phase shifter. A plurality of signal paths may be used together for the beamforming. For example, if the phase array system operates in the TDD method, signals may be transmitted through one or more transmission processing circuitry in a first time period and signals may be received through one or more reception circuitry in a second time period. However, reception circuitry (circuitries) may not perform separate signal processing in the first time period. In the second time period, the transmission circuitry (circuitries) may not perform separate signal processing. In various embodiments of the present disclosure, a technique for transmitting signals in a different frequency band, using reception circuitry (circuitries) not used in the transmission while transmitting signals in a specific frequency band is described. In addition, a technique for receiving signals in a different frequency band, using the transmission circuitry (circuitries) not used in the reception while receiving signals in a specific frequency band is described. For example, the electronic device 101 may include the antenna module 230 for transmitting and receiving signals according to the FDD method.

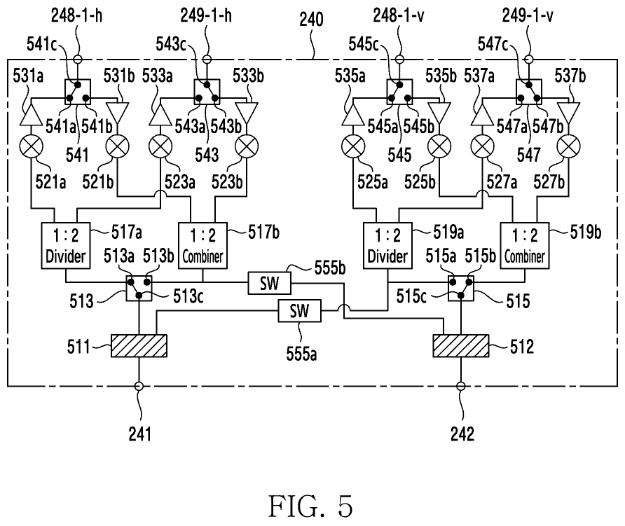

Referring to FIG. 4A, a graph 400a represents time-frequency usage of the electronic device 101. A horizontal axis of the graph 400a represents time and a vertical axis represents a frequency. The electronic device 101 may support a first frequency band 411 (e.g., an n257 band, an n258 band, or an n261 band) and a second frequency band 412 (e.g., an n260 band, or an n259 band). The electronic device 101 may transmit or receive a signal in the first frequency band 411. The electronic device 101 may transmit or receive a signal in the second frequency band 412. According to an embodiment, the electronic device 101 may receive signals on the second frequency band 412 (e.g., a downlink (DL)) while transmitting signals on the first frequency band 411 (e.g., an uplink (UL)). The electronic device 101 may perform control of the radio frequency processing circuitry 240 of the antenna module 230. While at least a portion of transmission processing circuitry of the radio frequency processing circuitry 240 process the signals of the first frequency band 411, at least a portion of reception processing circuitry of the radio frequency processing circuitry 240 may be configured to process the signals of the second frequency band 412. A structure of the radio frequency processing circuitry 240 will be described in greater detail below with reference to FIGS. 5 to 9.

Referring to FIG. 4B, a graph 400b represents time-frequency usage of the electronic device 101. A horizontal axis of the graph 400b represents time and a vertical axis represents a frequency. The electronic device 101 may support the first frequency band 411 and the second frequency band 412. For example, the electronic device 101 may perform an TDD operation with respect to the first frequency band 411. On the other hand, the second frequency band 412 may be used only for reception. The electronic device 101 may transmit or receive a signal in the first frequency band 411. The electronic device 101 may receive a signal in the second frequency band 412. According to an embodiment, the electronic device 101 may receive the signals on the second frequency band 412 while transmitting the signals on the first frequency band 411. While at least a portion of the transmission processing circuitry of the radio frequency processing circuitry 240 process the signals of the first frequency band 411, the reception processing circuitry of the radio frequency processing circuitry 240 may be configured to process the signals of the second frequency band 411. In addition, according to an embodiment, the electronic device 101 may receive the signals on the second frequency band 412, while receiving the signals on the first frequency band 411. In the electronic device 101, inter-band carrier aggregation (CA) for receiving signals in two different frequency bands may be configured. While at least a portion of the reception processing circuitry of the radio frequency processing circuitry 240 processes the signals of the first frequency band 411, at least another portion of the reception processing circuitry of the radio frequency processing circuitry 240 may be configured to process the signals of the second frequency band 412.

Referring to FIG. 4C, a graph 400c represents time-frequency usage of the electronic device 101. A horizontal axis of the graph 400c represents time and a vertical axis represents frequency. The electronic device 101 may support the first frequency band 411 and the second frequency band 412. For example, the electronic device 101 may perform the TDD operation with respect to the first frequency band 411. On the other hand, the second frequency band 412 may be used only for transmission. The electronic device 101 may transmit or receive a signal in the first frequency band 411. The electronic device 101 may transmit a signal in the second frequency band 412. According to an embodiment, the electronic device 101 may transmit the signals on the second frequency band 412 while receiving the signals on the first frequency band 411. While at least a portion of the transmission processing circuitry of the radio frequency processing circuitry 240 process the signals of the first frequency band 411, the reception processing circuitry of the radio frequency processing circuitry 240 may be configured to process the signals of the second frequency band 411. In addition, according to an embodiment, the electronic device 101 may transmit the signals on the second frequency band 412, while transmitting the signals on the first frequency band 411. In the electronic device 101, the inter-band CA (e.g., UL CA) for receiving the signals in two different frequency bands may be configured. While at least a portion of the reception processing circuitry of the radio frequency processing circuitry 240 processes the signals of the first frequency band 411, at least another portion of the reception processing circuitry of the radio frequency processing circuitry 240 may be configured to process the signals of the second frequency band 412.

As described above, according to the FDD method, resource efficiency for the electronic device 101 may be improved by receiving signals in a different frequency band while transmitting signals in a specific frequency band. Hereinafter, with reference to FIGS. 5 to 9, a structure of the radio frequency processing circuitry 240 for transmitting the signals in a different frequency band, using reception circuitry not used for the transmission while transmitting the signals in the specific frequency band will be described in greater detail.

FIG. 5 is a diagram illustrating an example configuration of radio frequency processing circuitry (e.g., radio frequency processing circuitry 240) according to various embodiments. In FIG. 5, in order to describe a circuitry structure of the radio frequency processing circuitry 240, an example in which RF ports of the radio frequency processing circuitry 240 are four is described but the four RF ports are simply an example and are not interpreted as limiting the present disclosure.

Referring to FIG. 5, the radio frequency processing circuitry 240 may include a plurality of transmission circuitry and a plurality of reception circuitry. For example, the transmission circuitry may include first transmission circuitry for transmitting signals of a first polarization (e.g., a horizontal polarization) and second transmission circuitry for transmitting signals of a second polarization (e.g., a vertical polarization). For example, the reception circuitry may include a first reception circuitry for receiving the signals of the first polarization (e.g., the horizontal polarization) and a second reception circuitry for receiving the signals of the second polarization (e.g., the vertical polarization). Each transmission circuitry may include one or more transmission processing circuitry. Each transmission processing circuitry may include RF components (e.g., a mixer, a power amplifier (PA)) for transmission signal processing. Each reception circuitry may include one or more reception processing circuitry. Each reception processing circuitry may include RF components (e.g., a mixer, a low noise amplifier (or LNA)) for reception signal processing.

According to an embodiment, the radio frequency processing circuitry 240 may be configured to process signals to be transmitted and/or signals received through an antenna element for a first frequency band (e.g., a LB of FR2, an n257 band, an n258 band, or an n261 band). The signals may correspond to the first polarization (e.g., the horizontal polarization). For example, the radio frequency processing circuitry 240 may include first transmission processing circuitry for the first frequency band and first reception processing circuitry for the first frequency band. The first transmission processing circuitry may include a mixer 521a and a PA 531a. The first reception processing circuitry may include a mixer 521b and an LNA 531b. One of the first transmission processing circuitry and the first reception processing circuitry may be connected to a 1-1 RF port 248-1-h through a transmit-receive switching circuit 541 (e.g., a single pole double throw (SPDT)). For example, a first throw 541a of the transmit-receive switching circuit 541 may be connected to the first transmission processing circuitry, and a second throw 541b of the transmit-receive switching circuit 541 may be connected to the first reception processing circuitry. A pole 541c of the transmit-receive switching circuit 541 may be connected to the 1-1 RF port 248-1-h.

According to an embodiment, the radio frequency processing circuitry 240 may be configured to process signals to be transmitted and/or signals received through an antenna element for a second frequency band (e.g., an HB of FR2, an n259 band, or an n260 band). The signals may correspond to the first polarization (e.g., the horizontal polarization). For example, the radio frequency processing circuitry 240 may include second transmission processing circuitry for the second frequency band and second reception processing circuitry for the second frequency band. The second transmission processing circuitry may include a mixer 523a and a PA 533a. The second reception processing circuitry may include a mixer 523b and an LNA 533b. One of the second transmission processing circuitry and the second reception processing circuitry may be connected to a 2-1 RF port 249-1-h through a transmit-receive switching circuit 543 (e.g., an SPDT). For example, a first throw 543a of the transmit-receive switching circuit 543 may be connected to the second transmission processing circuitry, and a second throw 543b of the transmit-receive switching circuit 543 may be connected to the second reception processing circuitry. A pole 543c of the transmit-receive switching circuit 543 may be connected to the 2-1 RF port 249-1-h.

According to an embodiment, the radio frequency processing circuitry 240 may be configured to process signals to be transmitted and/or signals received through the antenna element for the first frequency band (e.g., the LB of FR2, the n257 band, the n258 band, or the n261 band). The signals may correspond to the second polarization (e.g., the vertical polarization). For example, the radio frequency processing circuitry 240 may include third transmission processing circuitry for the first frequency band and third reception processing circuitry for the first frequency band. The third transmission processing circuitry may include a mixer 525a and a PA 535a. The third reception processing circuitry may include a mixer 525b and an LNA 535b. One of the third transmission processing circuitry and the third reception processing circuitry may be connected to a 3-1 RF port 248-1-v through a transmit-receive switching circuit 545 (e.g., an SPDT). For example, a first throw 545a of the transmit-receive switching circuit 545 may be connected to the third transmission processing circuitry, and a second throw 545b of the transmit-receive switching circuit 545 may be connected to the third reception processing circuitry. A pole 545c of the transmit-receive switching circuit 545 may be connected to the 3-1 RF port 248-1-v.

According to an embodiment, the radio frequency processing circuitry 240 may be configured to process signals to be transmitted and/or signals received through the antenna element for the second frequency band (e.g., the HB of FR2, the n259 band, or the n260 band). The signals may correspond to the second polarization (e.g., the vertical polarization). For example, the radio frequency processing circuitry 240 may include fourth transmission processing circuitry for the second frequency band and fourth reception processing circuitry for the second frequency band. The fourth transmission processing circuitry may include a mixer 527a and a PA 537a. The fourth reception processing circuitry may include a mixer 527b and an LNA 537b. One of the fourth transmission processing circuitry and the fourth reception processing circuitry may be connected to a 4-1 RF port 249-1-v through a transmit-receive switching circuit 547 (e.g., an SPDT). For example, a first throw 547a of the transmit-receive switching circuit 547 may be connected to the fourth transmission processing circuitry, and a second throw 547b of the transmit-receive switching circuit 547 may be connected to the fourth reception processing circuitry. A pole 547c of the transmit-receive switching circuit 547 may be connected to the 4-1 RF port 249-1-v.

The radio frequency processing circuit 240 may include one or more transmit-receive switching circuits connected to a first port 241 and/or a second port 242 to convert transmission and reception of a signal. For example, the radio frequency processing circuitry 240 may include a first transmit-receive switching circuit 513 for the first port 241 and a second transmit-receive switching circuit 515 for the second port 242.

According to an embodiment, the first transmit-receive switching circuit 513 may be configured to electrically connect the first port 241 to the first transmission circuitry or the first reception circuitry selectively. The first transmission circuitry may include the first transmission processing circuitry and the second transmission processing circuitry. The first transmission circuitry may include a divider 517a connected to the first transmission processing circuitry and the second transmission processing circuitry. The first reception circuitry may include the first reception processing circuitry and the second reception processing circuitry. The first reception circuitry may include a combiner 517b connected to the first reception processing circuitry and the second reception processing circuitry. As an example, the first transmit-receive switching circuit 513 may be an SPDT. A pole 513c of the first transmit-receive switching circuit 513 may be connected to the first port 241 (through first distribution circuitry 511). A first throw 513a of the first transmit-receive switching circuit 513 may be connected to the divider 517a for the first transmission circuitry. A first throw 513b of the first transmit-receive switching circuit 513 may be connected to the combiner 517b for the first reception circuitry.

According to an embodiment, a signal input to the first transmission circuitry may be transmitted to at least one of the first transmission processing circuitry or the second transmission processing circuitry through the divider 517a (e.g., a 1:2 divider). For example, in a case that signals of the first frequency band are transmitted and signals of the second frequency band are received, at least a portion of components (e.g., the mixer 523a or the PA 533a) of the second transmission processing circuitry may be deactivated, or the transmit-receive switching circuit 543 may not connect the second transmission processing circuitry to the 3-1 RF port 249-1-h. For example, in a case that the signals of the second frequency band are transmitted and the signals of the first frequency band are received, at least a portion of components (e.g., the mixer 521a, or the PA 531a) of the first transmission processing circuitry may be deactivated, or the transmit-receive switching circuit 541 may not connect the first transmission processing circuitry to the 1-1 RF port 248-1-h. For example, in a case that the signals of the first frequency band and the signals of the second frequency band are transmitted, all of the components (e.g., the mixer 521a or the PA 531a) of the first transmission processing circuitry and the components (e.g., the mixer 523a or the PA 533a) of the second transmission processing circuitry may be activated. The transmit-receive switching circuit 541 may connect the first transmission processing circuitry to the 1-1st RF port 248-1-h. The transmit-receive switching circuit 543 may connect the second transmission processing circuit to the 3-1 RF port 249-1-h. For example, the signal input to the first transmission circuitry may be transmitted to each of the first transmission processing circuitry and the second transmission processing circuitry through the divider 517a (e.g., the 1:2 divider).

According to an embodiment, the combiner 517b (e.g., a 1:2 combiner) may be configured to provide the first port 241 with an output signal of the first reception processing circuitry and/or an output signal of the second reception processing circuitry. For example, at least a portion of components (e.g., the mixer 521b, or the LNA 531b) of the first reception processing circuitry may be deactivated, and components (e.g., the mixer 523b, or the LNA 533b) of the second reception processing circuitry may be activated. The transmit-receive switching circuit 543 may electrically connect the 3-1 RF port 249-1-h to the second reception processing circuitry. The combiner 517b may provide the first port 241 with the received signals of the second frequency band. For example, the components (e.g., the mixer 521b, or the LNA 531b)of the first reception processing circuitry may be activated, and at least a portion of the components (e.g., the mixer 523b, or the LNA 533b) of the second reception processing circuitry may be deactivated. The transmit-receive switching circuit 541 may electrically connect the 1-1st RF port 248-1-h to the first reception processing circuitry. The combiner 517b may provide the first port 241 with the received signals of the first frequency band. For example, the components (e.g., the mixer 521b, or the LNA 531b) of the first reception processing circuitry and the components (e.g., the mixer 523b, or the LNA 533b) of the second reception processing circuitry may be activated. The transmit-receive switching circuit 541 may electrically connect the 1-1 RF port 248-1-h to the first reception processing circuitry. The transmit-receive switching circuit 543 may electrically connect the 3-1 RF port 249-1-h to the second reception processing circuitry. The combiner 517b may provide the first port 241 with a combined signal in which the received signals of the first frequency band and the received signals of the second frequency band are combined.

The second transmit-receive switching circuit 515 may be configured to electrically connect the second port 242 to the second transmission circuitry or the second reception circuitry selectively. The second transmission circuitry may include the third transmission processing circuitry and the fourth transmission processing circuitry. The second transmission circuitry may include a divider 519a connected to the third transmission processing circuitry and the fourth transmission processing circuitry. The second reception circuitry may include the third reception processing circuitry and the fourth reception processing circuitry. The second reception circuitry may include a combiner 519b connected to the third reception processing circuitry and the fourth reception processing circuitry. As an example, the second transmit-receive switching circuit 515 may be an SPDT. A pole 515c of the second transmit-receive switching circuit 515 may be connected to the second port 242 (through second distribution circuitry 512). A first throw 515a of the second transmit-receive switching circuit 515 may be connected to the divider 519a for the second transmission circuitry. A first throw 515b of the second transmit-receive switching circuit 515 may be connected to the combiner 519b for the second reception circuitry.

According to an embodiment, a signal input to the second transmission circuitry may be transmitted to at least one of the third transmission processing circuitry or the fourth transmission processing circuitry through the divider 519a (e.g., a 1:2 divider). For example, in a case that the signals of the first frequency band are transmitted and the signals of the second frequency band are received, at least a portion of components (e.g., the mixer 527a or the PA 537a) of the fourth transmission processing circuitry may be deactivated, or the transmit-receive switching circuit 547 may not connect the fourth transmission processing circuitry to the 4-1 RF port 249-1-v. For example, in a case that the signals of the second frequency band are transmitted and the signals of the first frequency band are received, at least a portion of components (e.g., the mixer 525a, or the PA 531a) of the third transmission processing circuitry may be deactivated, or the transmit-receive switching circuit 545 may not connect the third transmission processing circuitry to the 2-1 RF port 248-1-v. For example, in a case that the signals of the first frequency band and the signals of the second frequency band are transmitted, all of the components (e.g., the mixer 525a or the PA 535a) of the third transmission processing circuitry and the components (e.g., the mixer 527a or the PA 537a) of the fourth transmission processing circuitry may be activated. The transmit-receive switching circuit 545 may connect the third transmission processing circuitry to the 2-1 RF port 248-1-v. The transmit-receive switching circuit 547 may connect the fourth transmission processing circuitry to the 4-1 RF port 249-1-v. Herein, the signal input to the second transmission circuitry may be transmitted to each of the third transmission processing circuitry and the fourth transmission processing circuitry through the divider 519a (e.g., the 1:2 divider).

According to an embodiment, the combiner 519b (e.g., a 1:2 combiner) may be configured to provide the second port 242 with an output signal of the third reception processing circuitry and/or an output signal of the fourth reception processing circuitry. For example, at least a portion of components (e.g., the mixer 525b, or the LNA 535b) of the third reception processing circuitry may be deactivated, and components (e.g., the mixer 527b, or the LNA 537b) of the fourth reception processing circuitry may be activated. The transmit-receive switching circuit 547 may electrically connect the 4-1 RF port 249-1-v to the fourth reception processing circuitry. The combiner 519b may provide the second port 242 with the received signals of the second frequency band. For example, the components (e.g., the mixer 525b, or the LNA 535b) of the third reception processing circuitry may be activated, and at least a portion of the components (e.g., the mixer 527b, or the LNA 537b) of the fourth reception processing circuitry may be deactivated. The transmit-receive switching circuit 545 may electrically connect the 2-1 RF port 248-1-v to the third reception processing circuitry. The combiner 519b may provide the second port 242 with the received signals of the first frequency band. For example, the components (e.g., the mixer 525b, or the LNA 535b) of the third reception processing circuitry and the components (e.g., the mixer 527b, or the LNA 537b) of the fourth reception processing circuitry may be activated. The transmit-receive switching circuit 545 may electrically connect the 2-1 RF port 248-1-v to the third reception processing circuitry. The transmit-receive switching circuit 547 may electrically connect the 4-1 RF port 249-1-v to the fourth reception processing circuitry. The combiner 519b may provide the second port 242 with a combined signal in which the received signals of the first frequency band and the received signals of the second frequency band are combined.

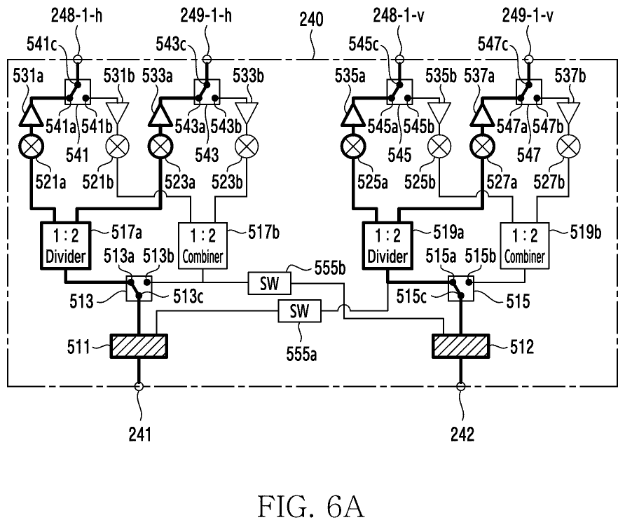

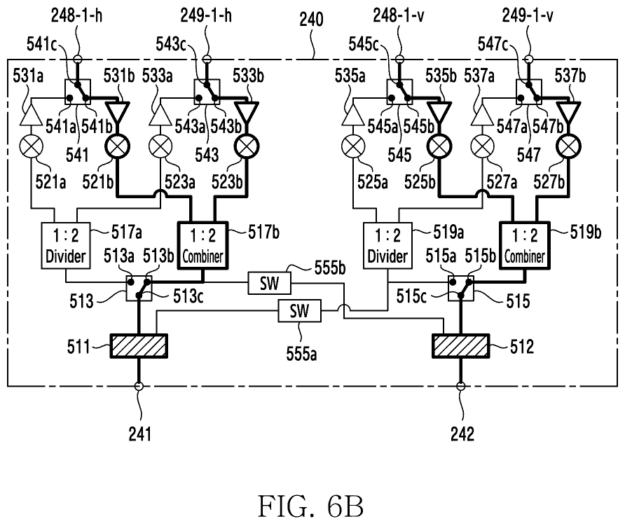

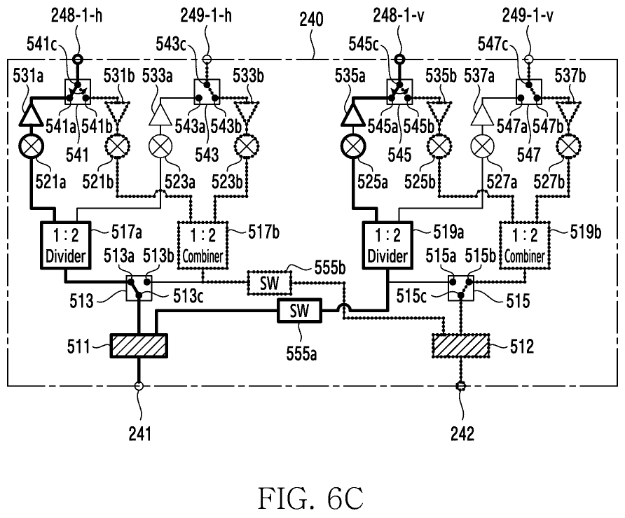

According to various embodiments of the present disclosure, the radio frequency processing circuitry 240 may include the first distribution circuitry 511 for providing the first transmission circuitry (e.g., the divider 517a and the first transmission processing circuitry and/or the second transmission processing circuitry connected to the divider 517a) and the second transmission circuitry (e.g., the divider 519a and the third transmission processing circuitry and/or the fourth transmission processing circuitry connected to the divider 519a) with signals input from the first port 241. According to various embodiments of the present disclosure, the radio frequency processing circuitry 240 may include a first control switching circuit 555a. The first distribution circuitry 511 may be connected to the first transmission circuitry through the first transmit-receive switching circuit 513, and may be connected to the second transmission circuitry through the first control switching circuit 555a. According to an embodiment, the first control switching circuit 555a may be configured to connect or not connect the first port 241 to the second transmission circuitry. An end of the first control switching circuit 555a may be connected to the first distribution circuitry 511, and another end of the first control switching circuit 555a may be connected to the divider 519a for the second transmission circuitry. An electronic device 101 may transmit signals on the first frequency band. The electronic device 101 may control the radio frequency processing circuitry 240 such that the signals input from the first port 241 are transmitted to each of the first transmission circuitry and the second transmission circuitry through the first distribution circuitry 511 and the first control switching circuit 555a. According to an embodiment, the electronic device 101 may control switching circuits (e.g., the transmit-receive switching circuit 541, the transmit-receive switching circuit 545, the first transmit-receive switching circuit 513, or the first control switching circuit 555a) of the radio frequency processing circuitry 240. For control of the switching circuits, FIGS. 6A, 6B, and 6C may be referenced.

As an example without limitation, the first distribution circuitry 511 and the first control switching circuit 555a may be used to combine the signals received from the first receiving circuitry and the signals received from the second receiving circuitry and provide them to the first port 241.

According to various embodiments of the present disclosure, the radio frequency processing circuitry 240 may include the second distribution circuitry 512 for combining signals of the first reception circuitry (e.g., the first reception processing circuitry, the second reception processing circuitry, and the combiner 517b connected to the first reception processing circuitry and/or the second reception processing circuitry) and/or signals of the second reception circuitry (e.g., the third reception processing circuitry, the fourth reception processing circuitry, and the combiner 519b connected to the third reception processing circuitry and/or the fourth reception processing circuitry) and providing them to the second port 242. According to various embodiments of the present disclosure, the radio frequency processing circuitry 240 may include a second control switching circuit 555b. The second distribution circuitry 512 may be connected to the second reception circuitry through the second transmit-receive switching circuit 515, and may be connected to the first reception circuitry through the second control switching circuit 555b. According to an embodiment, the second control switching circuit 555b may be configured to connect or not connect the second port 242 to the first reception circuitry. An end of the second control switching circuit 555b may be connected to the second distribution circuitry 512 and another end of the second control switching circuit 555b may be connected to the combiner 517b for the first reception circuitry. The electronic device 101 may transmit signals on the second frequency band. The electronic device 101 may control the radio frequency processing circuitry 240 such that all of the signals of the first reception circuitry and the signals of the second reception circuitry are transmitted to the second port 242 through the second distribution circuitry 512 and the second control switching circuit 555b. According to an embodiment, the electronic device 101 may control switching circuits (e.g., the transmit-receive switching circuit 543, the transmit-receive switching circuit 547, the second transmit-receive switching circuit 513, or the second control switching circuit 555b) of the radio frequency processing circuitry 240. For control of the switching circuits, FIGS. 6A, 6B, and 6C may be referred to.

As an example without limitation, the second distribution circuitry 512 and the second control switching circuit 555b may be used to combine the signals received from the first reception circuitry and the signals received from the second reception circuitry and provide them to the second port 242.

FIGS. 6A, 6B, and 6C are diagrams illustrating an example of an operation of components of radio frequency processing circuitry (e.g., the radio frequency processing circuitry 240) for each mode according to various embodiments. In order to describe operations of the components of the radio frequency processing circuitry 240, the radio frequency processing circuitry 240 of FIG. 5 may be referenced. The same reference numerals may be used to represent the same or similar description.

Referring to FIGS. 6A and 6B, an electronic device 101 may operate as a first mode (e.g., a TDD method). In FIG. 6A, a structure in which paths for transmission are activated is described. In the first mode, for a first time period, the electronic device 101 may be configured to transmit signals on a first frequency band (e.g., a LB of FR2, an n257 band, an n258 band, or an n261 band) and/or a second frequency band (e.g., an HB of FR2, an n259 band, or an n260 band). In FIG. 6B, a structure in which paths for reception are activated is described. In the first mode, the electronic device 101 may be configured to receive signals on the first frequency band and/or the second frequency band for a second time period distinct from the first time period.

Referring to FIG. 6A, in the first mode, a first control switching circuit 555a may be controlled to not electrically connect second transmission circuitry (through a divider 519a) to a first port 241 (through first distribution circuitry 511). In the first mode, a second control switching circuit 555b may be controlled to not electrically connect first reception circuitry (through a combiner 517b) to a second port 242 (through second distribution circuitry 512). In the first mode, a first transmit-receive switching circuit 513 may connect first transmission circuitry (through a divider 517a) to the first distribution circuitry 511. In the first mode, a transmit-receive switching circuit 541 may connect first transmission processing circuitry to a 1-1 RF port 248-1-h, and a transmit-receive switching circuit 543 may connect second transmission processing circuitry to a 3-1 RF port 249-1-h. In the first mode, a second transmit-receive switching circuit 515 may connect the second transmission circuitry (through the divider 519a) to the second distribution circuitry 512. In the first mode, a transmit-receive switching circuit 545 may connect a 2-1 RF port 248-1-v to third transmission processing circuitry, and a transmit-receive switching circuit 547 may connect fourth transmission processing circuitry to a 4-1 RF port 249-1-v.

Referring to FIG. 6A, in the first mode, the first control switching circuit 555a may be controlled to not electrically connect the second transmission circuitry (through the divider 519a) to the first port 241 (through the first distribution circuitry 511). In the first mode, the second control switching circuit 555b may be controlled to not electrically connect the first reception circuitry (through the combiner 517b) to the second port 242 (through the second distribution circuitry 512). In the first mode, the first transmit-receive switching circuit 513 may connect the first reception circuitry (through the combiner 517b) to the first distribution 511. In the first mode, the transmit-receive switching circuit 541 may connect first reception processing circuitry to the 1-1 RF port 248-1-h, and the transmit-receive switching circuit 543 may connect second reception processing circuitry to the 3-1 RF port 249-1-h. In the first mode, the second transmit-receive switching circuit 515 may connect second reception circuitry (through a combiner 519b) to the second distribution circuitry 512. In the first mode, the transmit-receive switching circuit 545 may connect third reception processing circuitry to the 2-1 RF port 248-1-v, and the transmit-receive switching circuit 547 may connect fourth reception processing circuitry to the 4-1 RF port 249-1-v.

When the electronic device 101 transmits a signal in the first mode, both the first transmit-receive switching circuit 513 and the second transmit-receive switching circuit 515 may electrically connect transmission circuitry to the first distribution circuitry 511. On the other hand, when the electronic device 101 receives a signal in the first mode, both the first transmit-receive switching circuit 513 and the second transmit-receive switching circuit 515 may electrically connect reception circuitry to the first distribution circuitry 511. If the first control switching circuit 555a and the second control switching circuit 555b are not activated, it may be difficult to perform transmission and reception of a signal at the same time. For an operation according to a FDD method, activation of the first control switching circuit 555a and the second control switching circuit 555b may be required. Hereinafter, in FIG. 6C, the electronic device 101 may operate as a second mode for the FDD method.

Referring to FIG. 6C, the electronic device 101 may operate as the second mode (e.g., the FDD method). A solid line represents paths for transmission activated in the radio frequency processing circuitry 240. In the second mode, the electronic device 101 may be configured to transmit signals on the first frequency band (e.g., the LB of FR2, the n257 band, the n258 band, or the n261 band). In the second mode, the first control switching circuit 555a may be controlled to connect the second transmission circuitry (through the divider 519a) to the first port 241 (through the first distribution circuitry 511). In the first mode, the first transmit-receive switching circuit 513 may connect the first transmission circuitry (through the divider 517a) to the first distribution 511. In the first mode, the transmit-receive switching circuit 541 may connect the first transmission processing circuitry of the first transmission circuitry to the 1-1 RF port 248-1-h, and the transmit-receive switching circuit 545 may connect the third transmission processing circuitry of the second transmission circuitry to the 2-1 RF port 248-1-v.

A dotted line represents paths for reception activated in the radio frequency processing circuitry 240. In the second mode, the electronic device 101 may be configured to receive signals on the second frequency band (e.g., the HB of FR2, the n259 band, or the n260 band) while signals are transmitted on the first frequency band. In the second mode, the second control switching circuit 555b may be controlled to connect the first reception circuitry (through the combiner 517b) to the second port 242 (through the second distribution circuitry 512). In the second mode, the second transmit-receive switching circuit 515 may connect the second reception circuitry (through the combiner 519b) to the second distribution 512. In the second mode, the transmit-receive switching circuit 543 may connect the second reception processing circuitry of the first reception circuitry to the 3-1 RF port 249-1-h, and a transmit-receive switching circuit 549 may connect the fourth reception processing circuitry of the second reception circuitry to the 4-1 RF port 249-1-v. In the second mode, the transmit-receive switching circuit 541 may connect the first reception processing circuitry to the 1-1 RF port 248-1-h, and the transmit-receive switching circuit 545 may connect the third reception processing circuitry to the 2-1 RF port 248-1-v. As an example, the transmit-receive switching circuit 541 may connect the 1-1 RF port 248-1-h to the first transmission processing circuitry or to the first reception processing circuitry at different times. As an example, the transmit-receive switching circuit 543 may connect the 2-1 RF port 248-1-v to the third transmission processing circuitry or the third reception processing circuitry at different times.

According to an embodiment, a processor 210 of the electronic device 101 may transmit a control signal (e.g., a control signal of an MIPI interface) to an antenna module 230. The control signal may be used to control an operation of switching circuits of the radio frequency processing circuitry 240 of the antenna module 230. For example, if the control signal indicates transmission in the first mode (e.g., the TDD method), the switching circuits of the radio frequency processing circuitry 240 may be controlled to a state according to FIG. 6A. For example, if the control signal indicates reception in the first mode (e.g., the TDD method), the switching circuits of the radio frequency processing circuitry 240 may be controlled to a state according to FIG. 6B. For example, if the control signal indicates the second mode (e.g., the FDD method), the switching circuits of the radio frequency processing circuitry 240 may be controlled to a state according to FIG. 6C. As the first mode is changed to the second mode, a role of the first port 241 and the second port 242 may be changed. For example, if the first port 241 functions as a port for a first polarization and the second port 242 functions as a port for a second polarization in the first mode, the first port 241 functions as the port for the transmission and the second port 242 functions as the port for the reception in the second mode.

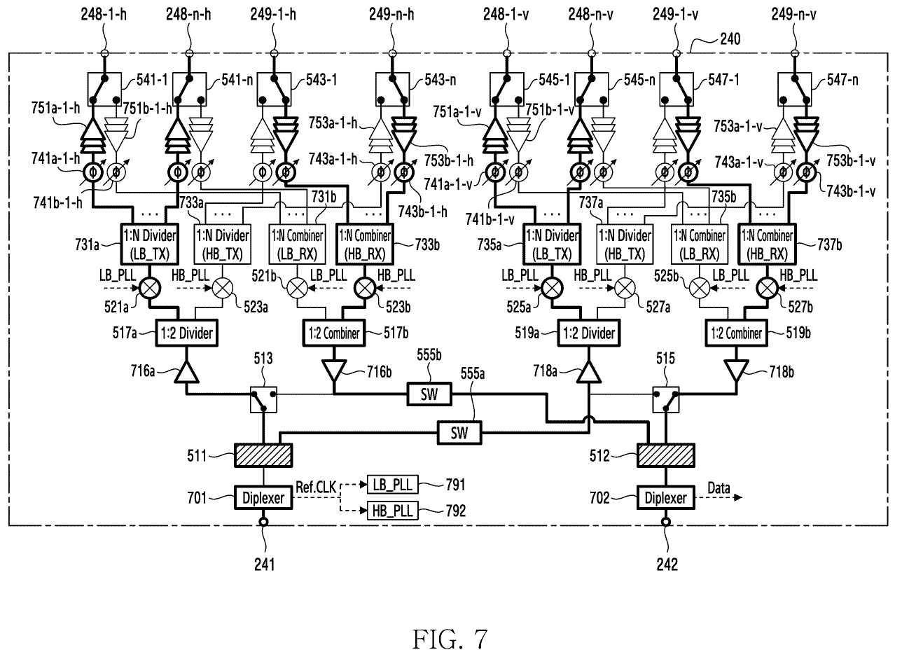

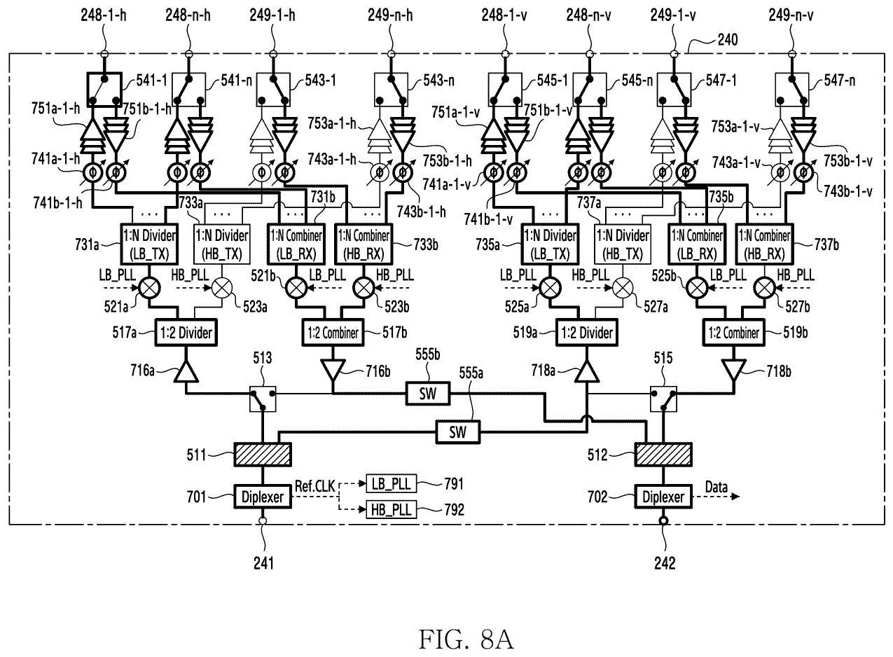

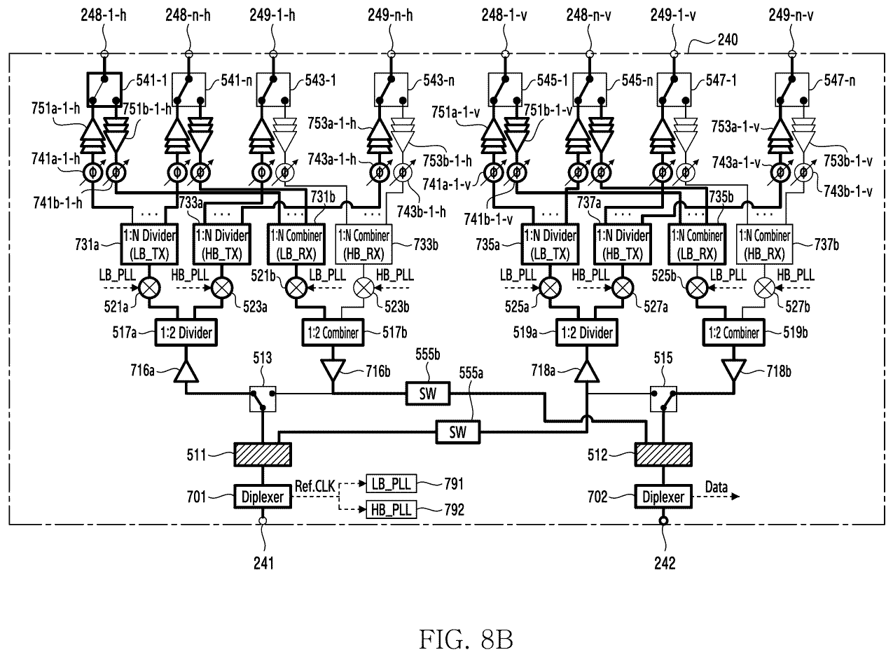

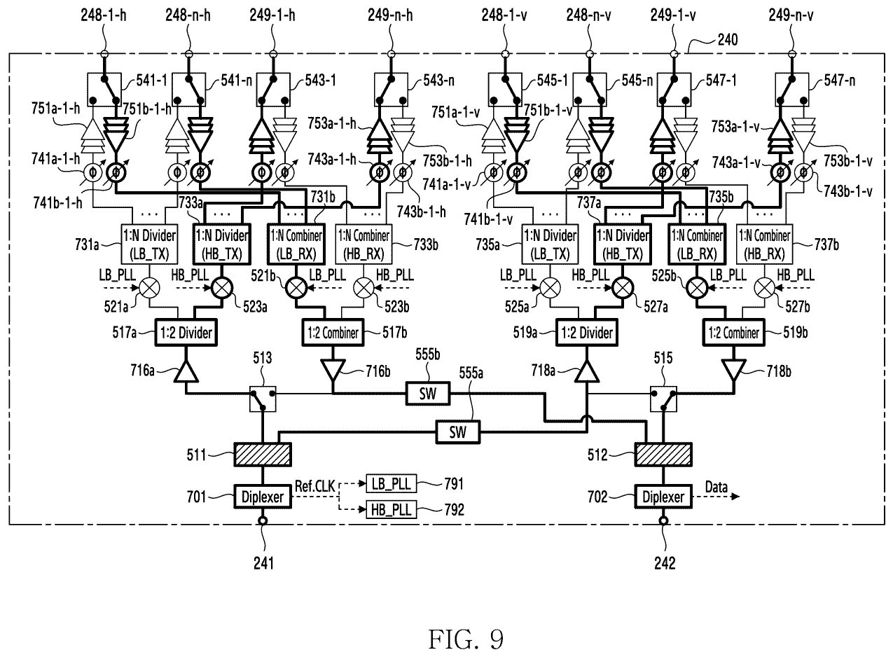

FIG. 7 is a diagram illustrating an example configuration of radio frequency processing circuitry (e.g., radio frequency processing circuitry 240) in a first communication type according to various embodiments. FIG. 8A is a diagram illustrating an example configuration of radio frequency processing circuitry (e.g., the radio frequency processing circuitry 240) in a second communication type according to various embodiments. FIG. 8B is a diagram illustrating an example configuration of radio frequency processing circuitry (e.g., the radio frequency processing circuitry 240) in a third communication type according to various embodiments. FIG. 9 is a diagram illustrating an example configuration of radio frequency processing circuitry (e.g., the radio frequency processing circuitry 240) in a fourth communication type according to various embodiments. In order to describe a circuitry structure of the radio frequency processing circuitry 240 according to each communication type, an example in which RF ports (e.g., a 1-1 RF port 248-1-h, a 2-1 RF port 248-1-v, a 3-1 RF port 249-1-h, or a 4-1 RF port 249-1-v) of the radio frequency processing circuitry 240 are four is described, but the four RF ports are simply an example and do not limit the present disclosure. In order to describe operations of the components of the radio frequency processing circuitry 240, the radio frequency processing circuitry 240 of FIG. 5 may be referenced. The same reference numerals may be used to represent the same or similar description.

Referring to FIGS. 7, 8A, 8B, and 9, an electronic device 101 may include the radio frequency processing circuitry 240. The radio frequency processing circuitry 240 may include a plurality of transmission circuitry and a plurality of reception circuitry. For example, the transmission circuitry may include first transmission circuitry for transmitting signals of a first polarization (e.g., a horizontal polarization) and second transmission circuitry for transmitting signals of a second polarization (e.g., a vertical polarization). For example, the reception circuitry may include first reception circuitry for receiving the signals of the first polarization (e.g., the horizontal polarization) and second reception circuitry for receiving the signals of the second polarization (e.g., the vertical polarization). Each transmission circuitry may include one or more transmission processing circuitry. Each transmission processing circuitry may include RF components (e.g., a mixer, a PA, or a phase shifter) for transmission signal processing. Each reception circuitry may include one or more reception processing circuitry. Each reception processing circuitry may include RF components (e.g., a mixer, an LNA, or a phase shifter) for reception signal processing.

According to an embodiment, the radio frequency processing circuitry 240 may be configured to process signals to be transmitted and/or signals received through an antenna element for a first frequency band. The signals may correspond to the first polarization. For example, the radio frequency processing circuitry 240 may include first transmission processing circuitry for the first frequency band and first reception processing circuitry for the first frequency band. The first transmission processing circuitry may include a mixer 521a, a divider 731a, 1-1 transmission processing circuitry for a 1-1 antenna element, 1-2 transmission processing circuitry for a 1-2 antenna element, . . . , and 1-n transmission processing circuitry for a 1-n antenna element. For example, the 1-1 transmission processing circuitry may include a phase shifter 741a-1-h and/or a PA 751a-1-h. The first reception processing circuitry may include a mixer 521b, a combiner 731b, 1-1 reception processing circuitry for the 1-1 antenna element, 1-2 reception processing circuitry for the 1-2 antenna element, . . . , and 1-n reception processing circuitry for the 1-n antenna element. For example, the 1-1 reception processing circuitry may include a phase shifter 741b-1-h and/or an LNA 751b-1-h. One of the 1-1 transmission processing circuitry and the 1-1 reception processing circuitry may be connected to the 1-1 RF port 248-1-h through a transmit-receive switching circuit 541-1 (e.g., an SPDT). In the same way, one of the 1-n transmission processing circuitry and the 1-n reception processing circuitry may be connected to a 1-n RF port 248-n-h through a transmit-receive switching circuit 541-n (e.g., an SPDT). For the transmit-receive switching circuit 541-1 to the transmit-receive switching circuit 541-n, descriptions of the transmit-receive switching circuit 541 of FIG. 5 may be referenced.

According to an embodiment, the radio frequency processing circuitry 240 may be configured to process signals to be transmitted and/or received signals through an antenna element for a second frequency band. The signals may correspond to the first polarization. For example, the radio frequency processing circuitry 240 may include second transmission processing circuitry for the second frequency band and second reception processing circuitry for the second frequency band. The second transmission processing circuitry may include a mixer 523a, a divider 733a, 2-1 transmission processing circuitry for a 2-1 antenna element, 2-2 transmission processing circuitry for a 2-2 antenna element, . . . , and 2-n transmission processing circuitry for a 2-n antenna element. For example, the 2-1 transmission processing circuitry may include a phase shifter 743a-1-h and/or a PA 753a-1-h. The second reception processing circuitry may include a mixer 523b, a combiner 733b, 2-1 reception processing circuitry for the 2-1 antenna element, 2-2 reception processing circuitry for the 2-2 antenna element, . . . , and 2-n reception processing circuitry for the 2-n antenna element. For example, the 2-1 reception processing circuitry may include a phase shifter 743b-1-h and/or an LNA 753b-1-h. One of the second transmission processing circuitry and the second reception processing circuitry may be connected to the 3-1 RF port 249-1-h through a transmit-receive switching circuit 543-1 (e.g., an SPDT). In the same way, one of the 2-n transmission processing circuitry and the 2-n reception processing circuitry may be connected to a 3-n RF port 249-n-h through a transmit-receive switching circuit 543-n (e.g., an SPDT). For the transmit-receive switching circuit 543-1 to the transmit-receive switching circuit 543-n, descriptions of the transmit-receive switching circuit 543 of FIG. 5 may be referenced to.

According to an embodiment, the radio frequency processing circuitry 240 may be configured to process signals to be transmitted and/or signals received through the antenna element for the first frequency band. The signals may correspond to the second polarization. For example, the radio frequency processing circuitry 240 may include third transmission processing circuitry for the first frequency band and third reception processing circuitry for the first frequency band. The third transmission processing circuitry may include a mixer 525a, a divider 735a, 3-1 transmission processing circuitry for the 1-1 antenna element, 3-2 transmission processing circuitry for the 1-2 antenna element, . . . , and 3-n transmission processing circuitry for the 1-n antenna element. The 3-1 transmission processing circuitry may include a phase shifter 741a-1-v and a PA 751a-1-v. The third reception processing circuitry may include a mixer 523b, a combiner 733b, 3-1 reception processing circuitry for the 1-1 antenna element, 3-2 reception processing circuitry for the 1-2 antenna element, . . . , and 3-n reception processing circuitry for the 1-n antenna element. For example, the 3-1 reception processing circuitry may include a mixer 525b, a combiner 735b, a phase shifter 741b-1-v, and/or an LNA 751b-1-v. One of the third transmission processing circuitry and the third reception processing circuitry may be connected to the 2-1 RF port 248-1-v through a transmit-receive switching circuit 545-1 (e.g., an SPDT). In the same way, one of the 3-n transmission processing circuitry and the 3-n reception processing circuitry may be connected to a 2-n RF port 248-n-v through a transmit-receive switching circuit 545-n (e.g., an SPDT). For the transmit-receive switching circuit 545-1, descriptions of the transmit-receive switching circuit 545 of FIG. 5 may be referenced.

According to an embodiment, the radio frequency processing circuitry 240 may be configured to process signals to be transmitted and/or signals received through the antenna element for the second frequency band. The signals may correspond to the second polarization. For example, the radio frequency processing circuitry 240 may include fourth transmission processing circuitry for the second frequency band and fourth reception processing circuitry for the second frequency band. The fourth transmission processing circuitry may include a mixer 527a, a divider 737a, 4-1 transmission processing circuitry for the 2-1 antenna element, 4-2 transmission processing circuitry for the 2-2 antenna element, . . . , and 4-n transmission processing circuitry for the 2-n antenna element. For example, the 4-1 transmission processing circuitry may include a phase shifter 743a-1-v and/or a PA 753a-1-v. The fourth reception processing circuitry may include a mixer 527b, a combiner 737b, 4-1 reception processing circuitry for the 2-1 antenna element, 4-2 reception processing circuitry for the 2-2 antenna element, . . . ., and 4-n reception processing circuitry for the 2-n antenna element. For example, the 4-1 reception processing circuitry may include a mixer 527b, a combiner 737b, a phase shifter 743b-1-v, and/or an LNA 753b-1-v. One of the fourth transmission processing circuitry and the fourth reception processing circuitry may be connected to the 4-1 RF port 249-1-v through a transmit-receive switching circuit 547-1 (e.g., an SPDT). In the same way, one of the 4-n transmission processing circuitry and the 4-n reception processing circuitry may be connected to a 4-n RF port 249-n-v through a transmit-receive switching circuit 547-n (e.g., an SPDT). For the transmit-receive switching circuit 547-1, descriptions of the transmit-receive switching circuit 547 of FIG. 5 may be referenced.

A first transmit-receive switching circuit 513 may be configured to electrically connect a first port 241 to the first transmission circuitry or the first reception circuitry selectively. The first transmission circuitry may include a PA 716a, the first transmission processing circuitry, and the second transmission processing circuitry. The first reception circuitry may include an LNA 716b, the first reception processing circuitry, and the second reception processing circuitry. A second transmit-receive switching circuit 515 may be configured to electrically connect a second port 242 to the second transmission circuitry or the second reception circuitry selectively. The second transmission circuitry may include a PA 718a, the third transmission processing circuitry, and the fourth transmission processing circuitry. The second reception circuitry may include an LNA 718b, the third reception processing circuitry, and the fourth reception processing circuitry.

According to an embodiment, the radio frequency processing circuitry 240 may include a first diplexer 701 and a second diplexer 702. In order to reduce an interface of the radio frequency processing circuitry 240, data and a reference clock signal may be multiplexed together at a port (e.g., the first port 241 and the second port 242) connected to intermediate frequency processing circuitry 220. The first diplexer 701 may be connected to the first port 241. The first diplexer 701 may be used to separate a signal input to the first port 241 from the reference clock signal. The second diplexer 702 may be connected to the second port 242. The second diplexer 702 may be used to separate a signal output to the second port 242 from a data signal.

According to an embodiment, the radio frequency processing circuitry 240 may include a first PLL circuit 791 for the first frequency band (e.g., an LB of FR2, an n257 band, an n258 band, or an n261 band) and a second PLL circuit 792 for the second frequency band (e.g., an HB of FR2, an n259 band, or an n260 band). The reference clock signal may be provided to the first PLL circuit 791. The first PLL circuit 791 may be configured to provide a mixer (e.g., the mixer 521a, or the mixer 525a) configured to up-convert a signal for the first frequency band, or a mixer (e.g., the mixer 521b, or the mixer 525b) configured to down-convert a signal for the first frequency band with an oscillation frequency, based on the reference clock signal. The second PLL circuit 792 may be configured to provide a mixer (e.g., the mixer 523a, or the mixer 527a) configured to upconvert a signal for the second frequency, or a mixer (e.g., the mixer 523b, or the mixer 527b) configured to down-convert a signal for the second frequency band with an oscillation frequency, based on the reference clock signal.

According to an embodiment, the electronic device 101 may operate according to the first communication type (e.g., corresponding to a FDD method in which signals may be received in the second frequency band while signals are transmitted in the first frequency band). In the first mode, the electronic device 101 may control the radio frequency processing circuitry 240 to transmit signals in the first frequency band (e.g., the n257 band, the n258 band, or the n261 band). While the signals are transmitted in the first frequency band, the electronic device 101 may control the radio frequency processing circuitry 240 to receive signals on the second frequency band (e.g., the n260 band, or the n259 band). Switching circuits (e.g., the first transmit-receive switching circuit 513, the second transmit-receive switching circuit 515, the transmit-receive switching circuit 541-1, the transmit-receive switching circuit 543-1, the transmit-receive switching circuit 545-1, the transmit-receive switching circuit 547-1, a first control switching circuit 555a in a connection state, or a second control switching circuit 555b in a connection state) of the radio frequency processing circuitry 240 may be controlled to a state according to FIG. 7.

According to an embodiment, the electronic device 101 may operate according to the second communication type (e.g., corresponding to a method in which signals perform (e.g., operating as the TDD in the first frequency band) transmission and reception in the first frequency band at different time, while signals are transmitted in the second frequency band). In the second mode, the electronic device 101 may control the radio frequency processing circuitry 240 to transmit or receive signals in the first frequency band (e.g., the n257 band, the n258 band, or the n261 band). For example, while the signals are transmitted in the first frequency band, the electronic device 101 may control the radio frequency processing circuitry 240 to receive signals on the second frequency band (e.g., the n260 band, or the n259 band). For another example, as an inter-band CA, the electronic device 101 may control the radio frequency processing circuitry 240 to receive the signals on the second frequency band (e.g., the n260 band or the n259 band) while the signals are received in the first frequency band. The switching circuits (e.g., the first transmit-receive switching circuit 513, the second transmit-receive switching circuit 515, the transmit-receive switching circuit 541-1, the transmit-receive switching circuit 543-1, the transmit-receive switching circuit 545-1, the transmit-receive switching circuit 547-1, the first control switching circuit 555a in the connection state, or the second control switching circuit 555b in the connection state) of the radio frequency processing circuitry 240 may be controlled to a state according to FIG. 8A.

According to an embodiment, the electronic device 101 may operate according to the third communication type (e.g., corresponding to a method in which signals perform (e.g., operating as the TDD in the first frequency band) transmission and reception in the first frequency band at different time, while signals are transmitted in the second frequency band). In the second mode, the electronic device 101 may control the radio frequency processing circuitry 240 to transmit or receive signals in the first frequency band (e.g., the n257 band, the n258 band, or the n261 band). For example, as an inter-band CA (e.g., UL CA), the electronic device 101 may control the radio frequency processing circuitry 240 to transmit signals on the second frequency band (e.g., the n260 band or the n259 band) while signals are received in the first frequency band. For another example, the electronic device 101 may control the radio frequency processing circuitry 240 to transmit the signals on the second frequency band (e.g., the n260 band or the n259 band) while the signals are received in the first frequency band. The switching circuits (e.g., the first transmit-receive switching circuit 513, the second transmit-receive switching circuit 515, the transmit-receive switching circuit 541-1, the transmit-receive switching circuit 543-1, the transmit-receive switching circuit 545-1, the transmit-receive switching circuit 547-1, the first control switching circuit 555a in the connection state, or the second control switching circuit 555b in the connection state) of the radio frequency processing circuitry 240 may be controlled to a state according to FIG. 8B.

According to an embodiment, the electronic device 101 may operate according to the fourth communication type (e.g., corresponding to a FDD method in which signals may be received in the first frequency band while signals are transmitted in the second frequency band). In the third mode, the electronic device 101 may control the radio frequency processing circuitry 240 to transmit signals on the second frequency band (e.g., the n260 band, the n259 band). While the signals are transmitted in the second frequency band, the electronic device 101 may control the radio frequency processing circuitry 240 to receive signals on the first frequency band (e.g., the n257 band, the n258 band, or the n261 band). The switching circuits (e.g., the first transmit-receive switching circuit 513, the second transmit-receive switching circuit 515, the transmit-receive switching circuit 541-1, the transmit-receive switching circuit 543-1, the transmit-receive switching circuit 545-1, the transmit-receive switching circuit 547-1, the first control switching circuit 555a in the connection state, or the second control switching circuit 555b in the connection state) of the radio frequency processing circuitry 240 may be controlled to a state according to FIG. 9.

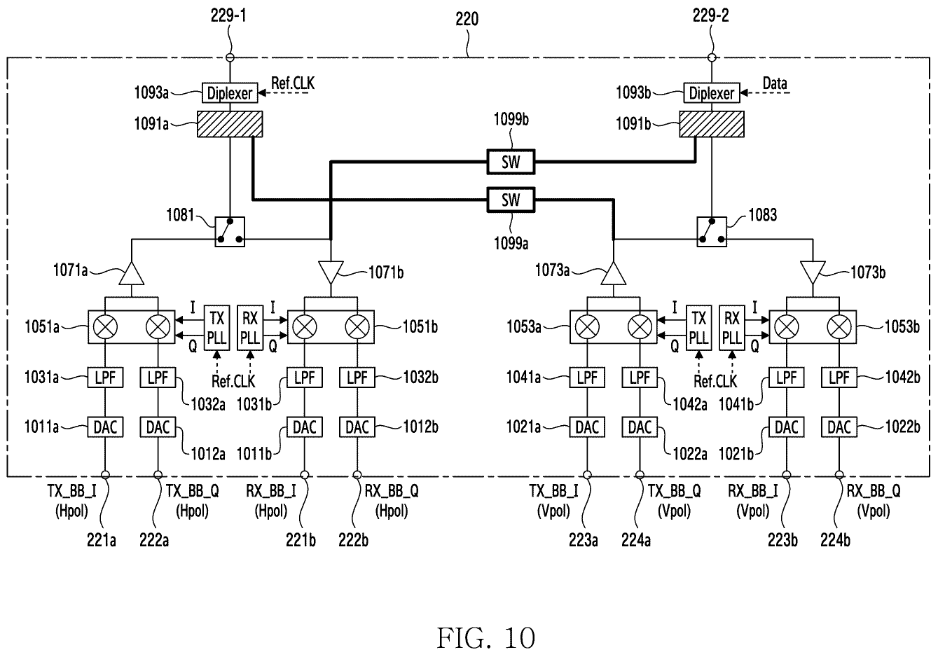

FIG. 10 is a diagram illustrating an example configuration of intermediate frequency processing circuitry (e.g., intermediate frequency processing circuitry 220) according to various embodiments.

Referring to FIG. 10, an electronic device 101 may include the intermediate frequency processing circuitry 220. The intermediate frequency processing circuitry 220 may include a plurality of transmission circuitry and a plurality of reception circuitry. For example, the transmission circuitry may include transmission circuitry for a first polarization (e.g., a horizontal polarization) and transmission circuitry for a second polarization (e.g., a vertical polarization). Each transmission circuitry may include one or more transmission processing circuitry. For example, the reception circuitry may include reception circuitry for the first polarization (e.g., the horizontal polarization) and reception circuitry for the second polarization (e.g., the vertical polarization). Each transmission processing circuitry may include RF components (e.g., a DAC, a filter, a mixer, or a PA) for transmission signal processing. Each reception circuitry may include one or more reception processing circuitry. Each reception processing circuitry may include RF components (e.g., an ADC, a filter, a mixer, or an LNA) for reception signal processing.

The intermediate frequency processing circuitry 220 may be connected to a processor 210. According to an embodiment, the intermediate frequency processing circuitry 220, which an IFIC, may include a plurality of ports connected to the processor 210. A 1-1 transmission port 221a of the intermediate frequency processing circuitry 220 may be connected to first transmission processing circuitry (e.g., a DAC 1011a, an LPF 1031a, a mixer 1051a, or a PA 1071a) for processing an in-phase (I) signal. A 1-2 transmission port 222a of the intermediate frequency processing circuitry 220 may be connected to second transmission processing circuitry (e.g., a DAC 1012a, an LPF 1032a, a mixer 1051a, or a PA 1071a) for processing a quadrature (Q) signal. A 1-1 reception port 221b of the intermediate frequency processing circuitry 220 may be connected to first reception processing circuitry (e.g., an ADC 1011b, an LPF 1031b, a mixer 1051b, or an LNA 1071b) for processing the I signal. A 1-2 reception port 222b of the intermediate frequency processing circuitry 220 may be connected to second reception processing circuitry (e.g., an ADC 1012b, an LPF 1032b, a mixer 1051b, or an LNA 1071b) for processing the Q signals. The 2-1 transmission port 231a of the intermediate frequency processing circuit 220 may be connected to first transmission processing circuitry (e.g., DAC 1021a, LPF 1041a, mixer 1053a, or PA 1073a) for processing the I signal. A 2-2 transmission port 232a of the intermediate frequency processing circuitry 220 may be connected to second transmission processing circuitry (e.g., a DAC 1022a, an LPF 1042a, a mixer 1053a, or a PA 1073a) for processing the Q signal. A 2-1 reception port 231b of the intermediate frequency processing circuitry 220 may be connected to first reception processing circuitry (e.g., an ADC 1021b, an LPF 1041b, a mixer 1053b, or an LNA 1073b) for processing the I signal. A 2-2 reception port 232b of the intermediate frequency processing circuitry 220 may be connected to second reception processing circuitry (e.g., an ADC 1022b, an LPF 1042b, a mixer 1053b, or a LNA 1073b) for processing the Q signal.

According to various embodiments of the present disclosure, a first IF port 229-1 may be connected to a first transmit-receive switching circuit 1081 and a second transmit-receive switching circuit 1083 through first distribution circuitry 1091a. A second IF port 229-2 may be connected to the first transmit-receive switching circuit 1081 and the second transmit-receive switching circuit 1083 through second distribution circuitry 1091b. According to an embodiment, the intermediate frequency processing circuitry 220 may include a first control switching circuit 1099a configured to connect or not connect the first distribution circuitry 1091a and the second transmit-receive switching circuit 1083. According to an embodiment, the intermediate frequency processing circuitry 220 may include a second control switching circuit 1099b configured to connect or not connect the second distribution circuitry 1091b and the first transmit-receive switching circuit 1081. Operations of the first control switching circuit 1099a and the second control switching circuit 1099b may be performed according to a control signal (e.g., a control signal of an MIPI interface) transmitted to the intermediate frequency processing circuitry 220 from the processor 210.

In an embodiment, through the operations of the first control switching circuitry 1099a and the second control switching circuit 1099b, the first IF port 229-1 may function as a port for transmission and the second IF port 229-2 may function as a port for reception.

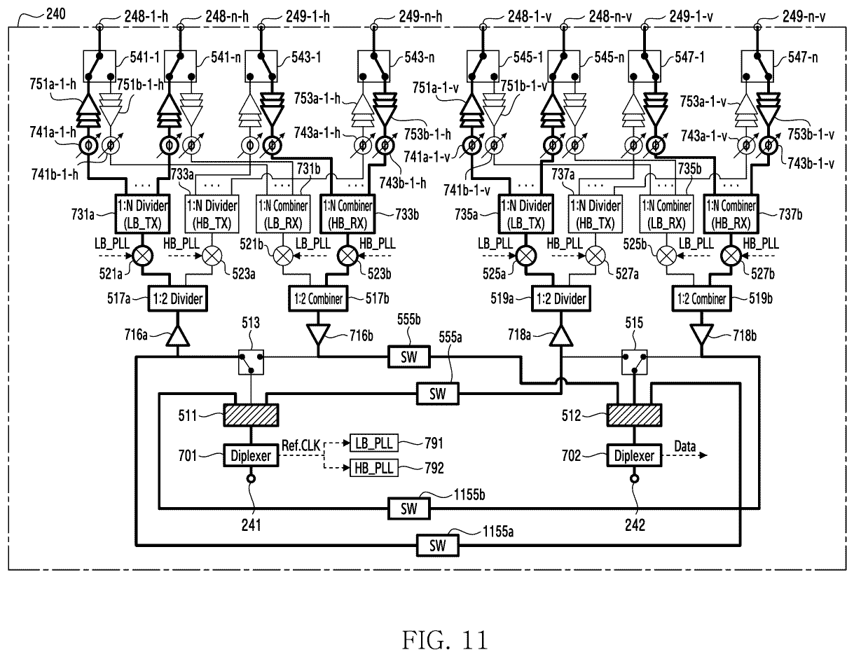

FIG. 11 is a diagram illustrating an example configuration of radio frequency processing circuitry (e.g., radio frequency processing circuitry 240) for transmit-receive switching between ports (e.g., a first port 241 or a second port 242) according to various embodiments. In order to describe a circuitry structure of the radio frequency processing circuitry 240, an example in which RF ports of the radio frequency processing circuitry 240 are four is described, but the four RF ports are only an example and are not interpreted as limiting embodiments of the present disclosure. In order to describe operations of the components of the radio frequency processing circuitry 240, the radio frequency processing circuitry 240 of FIG. 5 may be referenced. The same reference numerals may be used to represent the same or similar description.

Referring to FIG. 11, an electronic device 101 may include the radio frequency processing circuitry 240. The radio frequency processing circuitry 240 may include a plurality of transmission circuitry and a plurality of reception circuitry. Each transmission circuitry may include one or more transmission processing circuitry. Each transmission processing circuitry may include RF components (e.g., a mixer, a PA, or a phase shifter) for transmission signal processing. Each reception circuitry may include one or more reception processing circuitry. Each reception processing circuitry may include RF components (e.g., a mixer, an LNA, or a phase shifter) for reception signal processing. For each component, the descriptions of FIGS. 7, 8A, 8B, and 9 may be referenced.

According to an embodiment, the radio frequency processing circuitry 240 may include additional control switching circuits for transmit-receive switching between ports (e.g., the first port 241 or the second port 242). In a circuitry structure according to FIGS. 7, 8A, 8B, and 9, according to a FDD method, the first port 241 of the radio frequency processing circuitry 240 may operate as a port for transmission (hereinafter, a transmission port), and the second port 242 may function as a port for reception (hereinafter, a reception port). However, it may be difficult for the first port 241 to function as the reception port and for the second port 242 to function as the transmission port.

According to an embodiment, the radio frequency processing circuitry 240 may include a third control switching circuit 1155a. The third control switching circuit 1155a may be configured to connect or not connect second distribution circuitry 512 and first transmission circuitry (e.g., a PA 716a, a divider 517a, and first transmission processing circuitry and/or second transmission processing circuitry connected to the divider 517a). For example, the second distribution circuitry 512 may function as a splitter/combiner having at least three branches (e.g., 1:3). According to an embodiment, the radio frequency processing circuitry 240 may include a fourth control switching circuit 1155b. The fourth control switching circuit 1155b may be configured to connect or not connect first distribution circuitry 511 to second reception circuitry (e.g., a combiner 519b, an LNA 718b, and third reception processing circuitry and/or fourth reception processing circuitry connected to the combiner 519b). For example, the first distribution circuitry 511 may function as a splitter/combiner having at least three branches (e.g., 1:3). Operations of control switching circuits (e.g., a first control switching circuit 555a, a second control switching circuit 555b, the third control switching circuit 1155a, or the fourth control switching circuit 1155b) may be controlled by the radio frequency processing circuitry 240. The radio frequency processing circuitry 240 may be controlled through a control signal (e.g., a control signal of an MIPI interface) of a processor 210.

According to an embodiment, in a mode (hereinafter, a first transmit-receive mode) in which the first port 241 functions as the transmission port and the second port 242 functions as the reception port, the first control switching circuit 555a may be controlled to connect the first distribution circuitry 511 to second transmission circuitry (e.g., a PA 718a, a divider 519a, and third transmission processing circuitry and/or fourth transmission processing circuitry connected to the divider 519a). In the first transmit-receive mode, the second control switching circuit 555b may be controlled to connect the second distribution circuitry 512 to first reception circuitry (e.g., an LNA 716b, a combiner 517b, and first reception processing circuitry and/or second reception processing circuitry connected to the combiner 517b). In the first transmit-receive mode, the third control switching circuit 1155a may be controlled to not connect the second distribution circuitry 512 and the first transmission circuitry. In the first transmit-receive mode, the fourth control switching circuit 1155b may be controlled to not connect the first distribution circuitry 511 and the second reception circuitry.

According to an embodiment, in a mode (hereinafter, a second transmit-receive mode) in which the first port 241 functions as the transmission port and the second port 242 functions as the reception port, the first control switching circuit 555a may be controlled to not connect the first distribution circuitry 511 to the second transmission circuitry (e.g., the PA 718a, the divider 519a, and the third transmission processing circuitry and/or the fourth transmission processing circuitry connected to the divider 519a). In the first transmit-receive mode, the second control switching circuit 555b may be controlled to not connect the second distribution circuitry 512 to the first reception circuitry (e.g., the LNA 716b, the combiner 517b, and the first reception processing circuitry and/or the second reception processing circuitry connected to the combiner 517b). In the first transmit-receive mode, the third control switching circuit 1155a may be controlled to connect the second distribution circuitry 512 and the first transmission circuitry. In the first transmit-receive mode, the fourth control switching circuit 1155b may be controlled to connect the first distribution circuitry 511 and the second reception circuitry.

In the present disclosure, an FR2 band has been described as an example, but this is only an example and is not interpreted as limiting embodiments of the present disclosure. Even in a FR1 or LTE band, any communication equipment including the radio frequency processing circuitry 240 having the above-described structure may be understood as an embodiment of the present disclosure. In addition, in the present disclosure, an antenna module 230 of the electronic device 101 is described as an example, but embodiments of the present disclosure are not limited thereto. According to an embodiment, any communication equipment (e.g., a base station, or a satellite) having the radio frequency processing circuitry 240 may be understood as an embodiment of the present disclosure.

An antenna module (e.g., the antenna module 230) according to various embodiments of the present disclosure may provide high resource efficiency, using a control switching circuit (e.g., the first control switching circuit 555a or the second control switching circuit 555b) in the radio frequency processing circuitry 240.

The effects that may be obtained from the present disclosure are not limited to those described above, and any other effects not mentioned herein will be clearly understood by those having ordinary knowledge in the art to which the present disclosure belongs, from the following description.

The divider used in the present disclosure represents circuitry having elements for distributing a signal to each of ends, but in a case that a path at an end of the circuitry is disconnected or open, the divider may transmit an input signal to a connected end instead of distributing the signal. In addition, the combiner used in the present disclosure represents circuitry having elements for combining the signals input from the ends, but in a case that the path at the end of the circuitry is disconnected or open, the combiner may output the signal input from the connected end instead of combining the signal.

In various example embodiments of the present disclosure, an electronic device 101 is provided. The electronic device may comprise a processor, intermediate frequency processing circuitry 220 connected to the processor, radio frequency processing circuitry 240 connected to the intermediate frequency processing circuitry 220, and antennas connected to the radio frequency processing circuitry 240. The radio frequency processing circuitry 240 may include first transmission circuitry including first transmission processing circuitry for a first frequency band and second transmission processing circuitry for a second frequency band, second transmission circuitry including third transmission processing circuitry for the first frequency band and fourth transmission processing circuitry for the second frequency band, first reception circuitry including first reception processing circuitry for the first frequency band and second reception processing circuitry for the second frequency band, second reception circuitry including third reception processing circuitry for the first frequency band and fourth reception processing circuitry for the second frequency band, a first transmit-receive switching circuit configured to connect a first port connected to the intermediate frequency processing circuitry 220 to one of the first transmission circuitry and the first reception circuitry selectively, a second transmit-receive switching circuit configured to connect a second port connected to the intermediate frequency processing circuitry 220 to one of the second transmission circuitry and the second reception circuitry selectively, a first control switching circuit 555a configured to connect the first port connected to the intermediate frequency processing circuitry 220 to the second transmission circuitry or not, and a second control switching circuit 555b configured to connect the second port connected to the intermediate frequency processing circuitry 220 to the first reception circuitry or not.

For example, the radio frequency processing circuitry 240 may include first distribution circuitry 511 configured to connect the first port connected to the intermediate frequency processing circuitry 220 to each of the first transmit-receive switching circuit and the first control switching circuit 555a, and second distribution circuitry 512 configured to connect the second port connected to the intermediate frequency processing circuitry 220 to each of the second transmit-receive switching circuit and the second control switching circuit 555b.

For example, the radio frequency processing circuitry 240 may receive a control signal from the processor. The first control switching circuit 555a may be controlled to connect the first port to the second transmission circuitry while the first transmit-receive switching circuit connects the first port to the first transmission circuitry in a first mode in accordance with the control signal. The second control switching circuit 555b may be controlled to connect the second port to the first reception circuitry while the second transmit-receive switching circuit connects the second port to the second reception circuitry in the first mode in accordance with the control signal.

For example, the radio frequency processing circuitry 240 may receive a second control signal from the processor. The first control switching circuit 555a may be controlled to not connect the first port to the second transmission circuitry while the first transmit-receive switching circuit connects the first port to the first transmission circuitry in a second mode in accordance with the second control signal. The second control switching circuit 555b may be controlled to not connect the second port to the first reception circuitry while the second transmit-receive switching circuit connects the second port to the second reception circuitry in the second mode in accordance with the second control signal.

For example, the radio frequency processing circuitry 240 may include a first radio frequency (RF) port configured to be connected to one of the first transmission processing circuitry and the first reception processing circuitry selectively, a second RF port configured to be connected to one of the second transmission processing circuitry and the second reception processing circuitry selectively, a third RF port configured to be connected to one of the third transmission processing circuitry and the third reception processing circuitry selectively, and a fourth RF port configured to be connected to one of the fourth transmission processing circuitry and the fourth reception processing circuitry selectively. The antennas may include a first antenna for the first frequency band and a second antenna for the second frequency band. The first RF port and the third RF port may be connected to the first antenna. the second RF port and the fourth RF port may be connected to the second antenna.

For example, the radio frequency processing circuitry 240 may include a first output transmit-receive switching circuit configured to connect one of the first transmission processing circuitry and the first reception processing circuitry to the first RF port, a second output transmit-receive switching circuit configured to connect one of the second transmission processing circuitry and the second reception processing circuitry to the second RF port, a third output transmit-receive switching circuit configured to connect one of the third transmission processing circuitry and the third reception processing circuitry to the third RF port, and a fourth output transmit-receive switching circuit configured to connect one of the fourth transmission processing circuitry and the fourth reception processing circuitry to the fourth RF port.

For example, the first RF port may be used to output transmission signals of a first polarization or to obtain reception signals of the first polarization in the first frequency band. The second RF port may be used to output transmission signals of the first polarization or to obtain reception signals of the first polarization in the second frequency band. The third RF port may be used to output transmission signals of a second polarization or to obtain reception signals of the second polarization in the first frequency band. The fourth RF port may be used to output transmission signals of the second polarization or to obtain reception signals of the second polarization in the second frequency band.

For example, the first control switching circuit 555a may be connected to a node between the second transmission circuitry and the second transmit-receive switching circuit. The second control switching circuit 555b may be connected to a node between the first reception circuitry and the first transmit-receive switching circuit.

For example, the radio frequency processing circuitry 240 may be controlled to, in the first mode, transmit signals of the first frequency band through the first transmission processing circuitry and the third transmission processing circuitry based on the first port, and receive signals of the second frequency band through the second reception processing circuitry and the fourth reception processing circuitry, while the signals of the first frequency band are transmitted based on the second port. The radio frequency processing circuitry 240 may be controlled to, in a second mode different from the first mode, transmit signals of the first frequency band through the first transmission processing circuitry based on the first port, and transmit signals of the first frequency band through the third transmission processing circuitry based on the second port.

For example, the first transmission circuitry may include a first divider configured to connect the first transmit-receive switching circuit to the first transmission processing circuitry and the second transmission processing circuitry, respectively. The second transmission circuitry may include a second divider configured to connect the second transmit-receive switching circuit to the third transmission processing circuitry and the fourth transmission processing circuitry, respectively. The first reception circuitry may include a first combiner configured to connect the first transmit-receive switching circuit to the first reception processing circuitry and the second reception processing circuitry, respectively. The second reception circuitry may include a second combiner configured to connect the second transmit-receive switching circuit to the third reception processing circuitry and the fourth reception processing circuitry, respectively. The first control switching circuit 555a may be connected to a node between the second divider and the second transmit-receive switching circuit. The second control switching circuit 555b may be connected to a node between the first combiner and the first transmit-receive switching circuit.

For example, the intermediate frequency processing circuitry 220 may include first baseband transmission processing circuitry, first baseband reception processing circuitry, second baseband transmission processing circuitry, second baseband reception processing circuitry, a first intermediate frequency (IF) port connected to one of the first baseband transmission processing circuitry and the first baseband reception processing circuitry, a second IF port connected to one of the second baseband transmission processing circuitry and the second baseband reception processing circuitry, a first IF control switching circuit configured to connect or not connect the first IF port and the second baseband transmission processing circuitry, and a second IF control switching circuit configured to connect or not connect the second IF port and the first baseband reception processing circuitry.

For example, the first IF port may be connected to the first port of the radio frequency processing circuitry 240. The second IF port may be connected to the second port of the radio frequency processing circuitry 240.

For example, the first transmission processing circuitry may include a first transmission mixer for the first frequency band, a first power amplifier, and a first transmission phase shifter. The second transmission processing circuitry may include a second transmission mixer for the second frequency band, a second power amplifier, and a second transmission phase shifter. The third transmission processing circuitry may include a third transmission mixer for the first frequency band, a third power amplifier, and a third transmission phase shifter. The fourth transmission processing circuitry may include a fourth transmission mixer for the second frequency band, a fourth power amplifier, and a fourth transmission phase shifter. The first reception processing circuitry may include a first reception mixer for the first frequency band, a first low-noise amplifier, and a first reception phase shifter. The second reception processing circuitry may include a second reception mixer for the second frequency band, a second low-noise amplifier, and a second reception phase shifter. The third reception processing circuitry may include a third reception mixer for the first frequency band, a third low-noise amplifier, and a third reception phase shifter. The fourth reception processing circuitry may include a fourth reception mixer for the second frequency band, a fourth low-noise amplifier, and a fourth reception phase shifter.

For example, the radio frequency processing circuitry 240 may include a first phase-locked loop (PLL) circuit for the first frequency band. The radio frequency processing circuitry 240 may include a second PLL circuit for the second frequency band. The first PLL circuit may be configured to provide each of the first transmission mixer and the third transmission mixer with a first oscillation frequency. The second PLL circuit may be configured to provide each of the second reception mixer and the fourth reception mixer with a second oscillation frequency.

For example, the intermediate frequency processing circuitry 220 may be included in an intermediate frequency integrated circuit (IFIC). The radio frequency processing circuitry 240 may be included in a radio frequency integrated circuit (RFIC).

In various example embodiments of the present disclosure, an antenna module 230 is provided. The antenna module 230 may comprise a first port, a second port, radio frequency processing circuitry 240 connected to the first port and the second port, and antennas connected to the radio frequency processing circuitry 240. The radio frequency processing circuitry 240 may include first transmission circuitry including first transmission processing circuitry for a first frequency band and second transmission processing circuitry for a second frequency band, second transmission circuitry including third transmission processing circuitry for the first frequency band and fourth transmission processing circuitry for the second frequency band, first reception circuitry including first reception processing circuitry for reception signals of the first frequency band and second reception processing circuitry for reception signals of the second frequency band, second reception circuitry including third reception processing circuitry for reception signals of the first frequency band and fourth reception processing circuitry for reception signals of the second frequency band, a first transmit-receive switching circuit configured to connect the first port to one of the first transmission circuitry and the first reception circuitry selectively, a second transmit-receive switching circuit configured to connect the second port to one of the second transmission circuitry and the second reception circuitry selectively, a first control switching circuit 555a configured to connect the first port to the second transmission circuitry or not, and a second control switching circuit 555b configured to connect the second port to the first reception circuitry or not.

For example, the radio frequency processing circuitry 240 may include first distribution circuitry 511 configured to connect the first port to each of the first transmit-receive switching circuit and the first control switching circuit 555a, and second distribution circuitry 512 configured to connect the second port to each of the second transmit-receive switching circuit and the second control switching circuit 555b.

For example, the radio frequency processing circuitry 240 may include a first radio frequency (RF) port configured to be connected to one of the first transmission processing circuitry and the first reception processing circuitry selectively, a second RF port configured to be connected to one of the second transmission processing circuitry and the second reception processing circuitry selectively, a third RF port configured to be connected to one of the third transmission processing circuitry and the third reception processing circuitry selectively, and a fourth RF port configured to be connected to one of the fourth transmission processing circuitry and the fourth reception processing circuitry selectively. The antennas may include a first antenna for the first frequency band and a second antenna for the second frequency band. The first RF port and the third RF port may be connected to the first antenna. The second RF port and the fourth RF port may be connected to the second antenna.

For example, the first control switching circuit 555a may be connected to a node between the second transmission circuitry and the second transmit-receive switching circuit. The second control switching circuit 555b may be connected to a node between the first reception circuitry and the first transmit-receive switching circuit.

For example, the radio frequency processing circuitry 240 may correspond to a radio frequency integrated circuit (RFIC).

For one or more embodiments, at least one of components described in one or more of the preceding drawings may be configured to perform one or more operations, techniques, processes and/or methods as described in the present disclosure. For example, a processor (e.g., a baseband processor) described in the present disclosure in relation to one or more of the preceding drawings may be configured to operate according to one or more examples described in the present disclosure. For another example, circuitry related to a user equipment (UE), a base station, a network element, and the like as described above in relation to one or more of the previous drawings may be configured to operate according to one or more examples described here.

Any of embodiments described above may be combined with any other embodiment (or a combination of an embodiment) unless otherwise explicitly stated. The above-described description of one or more implementations provides an example and a description, but is not intended to limit or tighten a scope of an embodiment in a precise form disclosed. Modification and deformation may be made in light of the above teachings or may be obtained from an embodiment of various embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one processor comprising processing circuitry;
intermediate frequency (IF) processing circuitry connected to the at least one processor;
radio frequency (RF) processing circuitry connected to the intermediate frequency processing circuitry; and
antennas connected to the RF processing circuitry,
wherein the RF processing circuitry includes:
first transmission circuitry including first transmission processing circuitry for a first frequency band and second transmission processing circuitry for a second frequency band,
second transmission circuitry including third transmission processing circuitry for the first frequency band and fourth transmission processing circuitry for the second frequency band,
first reception circuitry including first reception processing circuitry for the first frequency band and second reception processing circuitry for the second frequency band,
second reception circuitry including third reception processing circuitry for the first frequency band and fourth reception processing circuitry for the second frequency band,
a first transmit-receive (Tx/Rx) switching circuit configured to selectively connect a first port connected to the IF processing circuitry to the first transmission circuitry or the first reception circuitry,
a second Tx/Rx switching circuit configured to selectively connect a second port connected to the IF processing circuitry to the second transmission circuitry or the second reception circuitry,
a first control switching circuit configured to selectively connect the first port connected to the IF processing circuitry to the second transmission circuitry, and
a second control switching circuit configured to selectively connect the second port connected to the IF processing circuitry to the first reception circuitry.

2. The electronic device of claim 1,
wherein the RF processing circuitry includes:
first distribution circuitry configured to connect the first port connected to the IF processing circuitry to each of the first Tx/Rx switching circuit and the first control switching circuit, and
second distribution circuitry configured to connect the second port connected to the IF processing circuitry to each of the second Tx/Rx switching circuit and the second control switching circuit.

3. The electronic device of claim 1,
wherein the RF processing circuitry is configured to receive a control signal from the at least one processor,
wherein the first control switching circuit is configured to be controlled to connect the first port to the second transmission circuitry while the first Tx/Rx switching circuit connects the first port to the first transmission circuitry in a first mode in accordance with the control signal, and
wherein the second control switching circuit is configured to be controlled to connect the second port to the first reception circuitry while the second Tx/Rx switching circuit connects the second port to the second reception circuitry in the first mode in accordance with the control signal.

4. The electronic device of claim 1,
wherein the RF processing circuitry is configured to receive a second control signal from the at least one processor,
wherein the first control switching circuit is configured to be controlled to not connect the first port to the second transmission circuitry while the first Tx/Rx switching circuit connects the first port to the first transmission circuitry in a second mode in accordance with the second control signal, and
wherein the second control switching circuit is configured to be controlled to not connect the second port to the first reception circuitry while the second Tx/Rx switching circuit connects the second port to the second transmission circuitry in the second mode in accordance with the second control signal.

5. The electronic device of claim 1,
wherein the RF processing circuitry includes:
a first radio frequency (RF) port configured to be selectively connected to one of the first transmission processing circuitry and the first reception processing circuitry;
a second RF port configured to be selectively connected to one of the second transmission processing circuitry and the second reception processing circuitry;
a third RF port configured to be selectively connected to one of the third transmission processing circuitry and the third reception processing circuitry; and
a fourth RF port configured to be selectively connected to one of the fourth transmission processing circuitry and the fourth reception processing circuitry;
wherein the antennas include a first antenna for the first frequency band and a second antenna for the second frequency band,
wherein the first RF port and the third RF port are connected to the first antenna, and
wherein the second RF port and the fourth RF port are connected to the second antenna.

6. The electronic device of claim 5,
wherein the RF processing circuitry includes:
a first output Tx/Rx switching circuit configured to connect one of the first transmission processing circuitry and the first reception processing circuitry to the first RF port;
a second output Tx/Rx switching circuit configured to connect one of the second transmission processing circuitry and the second reception processing circuitry to the second RF port;
a third output Tx/Rx switching circuit configured to connect one of the third transmission processing circuitry and the third reception processing circuitry to the third RF port; and
a fourth output Tx/Rx switching circuit configured to connect one of the fourth transmission processing circuitry and the fourth reception processing circuitry to the fourth RF port.

7. The electronic device of claim 5,
wherein the first RF port is configured to output transmission signals of a first polarization or to obtain reception signals of the first polarization in the first frequency band,
wherein the second RF port is configured to output transmission signals of the first polarization or to obtain reception signals of the first polarization in the second frequency band,
wherein the third RF port is configured to output transmission signals of a second polarization or to obtain reception signals of the second polarization in the first frequency band, and
wherein the fourth RF port is configured to output transmission signals of the second polarization or to obtain reception signals of the second polarization in the second frequency band.

8. The electronic device of claim 1,
wherein the first control switching circuit is connected to a node between the second transmission circuitry and the second Tx/Rx switching circuit, and
wherein the second control switching circuit is connected to a node between the first reception circuitry and the first Tx/Rx switching circuit.

9. The electronic device of claim 1,
wherein the RF processing circuitry is configured to be controlled to, in the first mode:
transmit signals of the first frequency band through the first transmission processing circuitry and the third transmission processing circuitry based on the first port, and
receive signals of the second frequency band through the second reception processing circuitry and the fourth reception processing circuitry, while the signals of the first frequency band are transmitted based on the second port, and
wherein the RF processing circuitry is configured to be controlled to, in a second mode different from the first mode:
transmit signals of the first frequency band through the first transmission processing circuitry based on the first port, and
transmit signals of the first frequency band through the third transmission processing circuitry based on the second port.

10. The electronic device of claim 1,
wherein the first transmission circuitry includes a first divider configured to connect the first Tx/Rx switching circuit to the first transmission processing circuitry and the second transmission processing circuitry, respectively,
wherein the second transmission circuitry includes a second divider configured to connect the second Tx/Rx switching circuit to the third transmission processing circuitry and the fourth transmission processing circuitry, respectively,
wherein the first reception circuitry includes a first combiner configured to connect the first Tx/Rx switching circuit to the first reception processing circuitry and the second reception processing circuitry, respectively,
wherein the second reception circuitry includes a second combiner configured to connect the second Tx/Rx switching circuit to the third reception processing circuitry and the fourth reception processing circuitry, respectively,
wherein the first control switching circuit is connected to a node between the second divider and the second Tx/Rx switching circuit, and
wherein the second control switching circuit is connected to a node between the first combiner and the first Tx/Rx switching circuit.

11. The electronic device of claim 1,
wherein the IF processing circuitry includes:
first baseband transmission processing circuitry;
first baseband reception processing circuitry;
second baseband transmission processing circuitry;
second baseband reception processing circuitry;
a first intermediate frequency (IF) port connected to one of the first baseband transmission processing circuitry and the first baseband reception processing circuitry;
a second IF port connected to one of the second baseband transmission processing circuitry and the second baseband reception processing circuitry;
a first IF control switching circuit configured to selectively connect the first IF port and the second baseband transmission processing circuitry; and
a second IF control switching circuit configured to selectively connect the second IF port and the first baseband reception processing circuitry.

12. The electronic device of claim 11,
wherein the first IF port is connected to the first port of the RF processing circuitry, and
wherein the second IF port is connected to the second port of the RF processing circuitry.

13. The electronic device of claim 1,
wherein the first transmission processing circuitry includes a first transmission mixer for the first frequency band, a first power amplifier, and a first transmission phase shifter,
wherein the second transmission processing circuitry includes a second transmission mixer for the second frequency band, a second power amplifier, and a second transmission phase shifter,
wherein the third transmission processing circuitry includes a third transmission mixer for the first frequency band, a third power amplifier, and a third transmission phase shifter,
wherein the fourth transmission processing circuitry includes a fourth transmission mixer for the second frequency band, a fourth power amplifier, and a fourth transmission phase shifter,
wherein the first reception processing circuitry includes a first reception mixer for the first frequency band, a first low-noise amplifier, and a first reception phase shifter,
wherein the second reception processing circuitry includes a second reception mixer for the second frequency band, a second low-noise amplifier, and a second reception phase shifter,
wherein the third reception processing circuitry includes a third reception mixer for the first frequency band, a third low-noise amplifier, and a third reception phase shifter, and
wherein the fourth reception processing circuitry includes a fourth reception mixer for the second frequency band, a fourth low-noise amplifier, and a fourth reception phase shifter.

14. The electronic device of claim 13,
wherein the RF processing circuitry includes:
a first phase-locked loop (PLL) circuit for the first frequency band, and
a second PLL circuit for the second frequency band,
wherein the first PLL circuit is configured to provide each of the first transmission mixer and the third transmission mixer with a first oscillation frequency, and
wherein the second PLL circuit is configured to provide each of the second reception mixer and the fourth reception mixer with a second oscillation frequency.

15. The electronic device of claim 1,
wherein the IF processing circuitry is included in an intermediate frequency integrated circuit (IFIC), and
wherein the RF processing circuitry is included in a radio frequency integrated circuit (RFIC).

16. An antenna module comprising:
a first port;
a second port;
radio frequency (RF) processing circuitry connected to the first port and the second port; and
antennas connected to the RF processing circuitry,
wherein the RF processing circuitry includes:
first transmission circuitry including first transmission processing circuitry for a first frequency band and second transmission processing circuitry for a second frequency band,
second transmission circuitry including third transmission processing circuitry for the first frequency band and fourth transmission processing circuitry for the second frequency band,
first reception circuitry including first reception processing circuitry for the first frequency band and second reception processing circuitry for the second frequency band,
second reception circuitry including third reception processing circuitry for the first frequency band and fourth reception processing circuitry for the second frequency band,
a first transmit-receive (Tx/Rx) switching circuit configured to connect the first port to the first transmission circuitry or the first reception circuitry selectively,
a second Tx/Rx switching circuit configured to connect the second port to the second transmission circuitry or the second reception circuitry selectively,
a first control switching circuit configured to connect the first port to the second transmission circuitry or not, and
a second control switching circuit configured to connect the second port to the first reception circuitry or not.

17. The antenna module of claim 16,
wherein the RF processing circuitry includes:
first distribution circuitry configured to connect the first port to each of the first Tx/Rx switching circuit and the first control switching circuit, and
second distribution circuitry configured to connect the second port to each of the second Tx/Rx switching circuit and the second control switching circuit.

18. The antenna module of claim 16,
wherein the RF processing circuitry includes:
a first radio frequency (RF) port configured to be selectively connected to one of the first transmission processing circuitry and the first reception processing circuitry;
a second RF port configured to be selectively connected to one of the second transmission processing circuitry and the second reception processing circuitry;
a third RF port configured to be selectively connected to one of the third transmission processing circuitry and the third reception processing circuitry; and
a fourth RF port configured to be selectively connected to one of the fourth transmission processing circuitry and the fourth reception processing circuitry;
wherein the antennas include a first antenna for the first frequency band and a second antenna for the second frequency band,
wherein the first RF port and the third RF port are connected to the first antenna, and
wherein the second RF port and the fourth RF port are connected to the second antenna.

19. The antenna module of claim 16,
wherein the first control switching circuit is connected to a node between the second transmission circuitry and the second Tx/Rx switching circuit, and
wherein the second control switching circuit is connected to a node between the first reception circuitry and the first Tx/Rx switching circuit.

20. The antenna module of claim 16, wherein the RF processing circuitry corresponds to a radio frequency integrated circuit (RFIC).
